(19) United States
(12) Patent Application Publication
(10) Pub. No.: US 2025/0168891 A1
(43) Pub. Date: May 22, 2025

(54) RESPONSE ENHANCEMENTS FOR MULTIPLE RANDOM ACCESS PROCEDURES

(71) Applicant: QUALCOMM INCORPORATED, San Diego, CA (US)

(72) Inventors: Shaozhen Guo, Beijing (CN); Mostafa Khoshnevisan, San Diego, CA (US); Peter Gaal, San Diego, CA (US); Jing Sun, San Diego, CA (US); Xiaoxia Zhang, San Diego, CA (US); Tao Luo, San Diego, CA (US); Yan Zhou, Beijing (CN); Fang Yuan, Beijing (CN)

(21) Appl. No.: 18/835,269

(22) PCT Filed: Mar. 31, 2022
(86) PCT No.: PCT/CN2022/084394

§ 371 Date: Aug. 1, 2024

(51) Int. Cl. H04W 74/0833; H04W 72/23; H04W 76/38

(52) U.S. Cl. CPC H04W 74/0833; H04W 72/23; H04W 76/38

(57) ABSTRACT

Methods, systems, and devices for wireless communications are described. A wireless communications system may support techniques for random access response (RAR) enhancements for multiple random access channel (RACH) procedures. In some cases, a user equipment (UE) may receive multiple physical downlink control channel (PDCCH) orders triggering respective RACH procedures, each PDCCH order indicating a preamble identifier associated with the respective RACH procedure. In some cases, the preamble identifiers may be the same or different. The UE may transmit a random access preamble corresponding to a preamble identifier indicated in a PDCCH order and may receive a random access response associated with a respective RACH procedure based at least in part on an indication included in the random access response. In some cases, the indication may be associated with a preamble identifier indication. In some other cases, the indication may be associated with a timing advance group.

### CROSS REFERENCE

The present Application is a 371 national stage filing of International PCT Application No. PCT/CN2022/084394 by Guo et al. entitled “RESPONSE ENHANCEMENTS FOR MULTIPLE RANDOM ACCESS PROCEDURES,” filed Mar. 31, 2022, which is assigned to the assignee hereof, and which is expressly incorporated by reference in its entirety herein.

### FIELD OF TECHNOLOGY

The following relates to wireless communications, including random access response (RAR) enhancements for multiple random access channel (RACH) procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support random access response (RAR) enhancements for multiple random access channel (RACH) procedures. Generally, the described techniques provide for a user equipment (UE) to determine to which random access procedure (e.g., RACH procedure) that an RAR corresponds based on an indication in the RAR (e.g., when one or more random access procedures are triggered while a first (e.g., initial) random access procedure is ongoing). For example, a UE may receive multiple physical downlink control channel (PDCCH) orders, where each PDCCH order is associated with a respective random access procedure. A PDCCH order may allocate or assign a random access preamble identifier associated with a respective random access procedure. In some cases, the random access preamble identifiers may be the same for multiple PDCCH order or in other cases the random access preamble identifiers may be different. The UE may transmit a random access preamble in response to each received PDCCH order, where each random access preamble is associated with a random access preamble identifier indicated in a corresponding PDCCH order. The UE may monitor or receive at least one RAR associated with one of the random access procedures.

In some cases (e.g., when each PDCCH order allocates a unique random access preamble identifier), the UE may receive the RAR and determine which random access procedure the RAR is associated with based on a random access preamble identifier indication included in the RAR. Additionally or alternatively, the UE may receive the RAR and determine which random access procedure the RAR is associated with based on an indication of a timing advance group included in the RAR. In some cases, the timing advance group may be indicated by a timing advance group indicator field in the RAR, a combination of a reserved field and a channel state information (CSI) request field in the RAR, a random access temporary identifier used to scramble a PDCCH in the RAR, one or more reserved bits in the PDCCH in the RAR, or a control resource set (CORESET) pool index associated with the PDCCH in the RAR.

In some examples, the UE may determine a timing advance group is associated with a random access procedure based on a CORESET pool index associated with the PDCCH order or a random accession occasion associated with a random access preamble. For example, a network entity may transmit a PDCCH order associated with a CORESET pool index triggering a random access procedure and the UE may determine that the CORESET pool index corresponds to a timing advance group. Thus, the UE may determine that the random access procedure triggered by the PDCCH order is associated with the timing advance group.

A method for wireless communications at a UE is described. The method may include receiving a first control message in a first PDCCH order triggering a first random access procedure, the first control message indicating a first preamble identifier associated with the first random access procedure, receiving a second control message in a second PDCCH order triggering a second random access procedure during the first random access procedure, the second control message indicating a second preamble identifier associated with the second random access procedure, where the first preamble identifier is different than the second preamble identifier, transmitting a first random access preamble corresponding to the first preamble identifier and a second random access preamble corresponding to the second preamble identifier, and receiving a RAR associated with one of the first random access procedure or the second random access procedure based on a preamble identifier indication included in the RAR.

An apparatus for wireless communications at a UE is described. The apparatus may include a processor, memory coupled with the processor, and instructions stored in the memory. The instructions may be executable by the processor to cause the apparatus to receive a first control message in a first PDCCH order triggering a first random access procedure, the first control message indicating a first preamble identifier associated with the first random access procedure, receive a second control message in a second PDCCH order triggering a second random access procedure during the first random access procedure, the second control message indicating a second preamble identifier associated with the second random access procedure, where the first preamble identifier is different than the second preamble identifier, transmit a first random access preamble corresponding to the first preamble identifier and a second random access preamble corresponding to the second preamble identifier, and receive a RAR associated with one of the first random access procedure or the second random access procedure based on a preamble identifier indication included in the RAR.

Another apparatus for wireless communications at a UE is described. The apparatus may include means for receiving a first control message in a first PDCCH order triggering a first random access procedure, the first control message indicating a first preamble identifier associated with the first random access procedure, means for receiving a second control message in a second PDCCH order triggering a second random access procedure during the first random access procedure, the second control message indicating a second preamble identifier associated with the second random access procedure, where the first preamble identifier is different than the second preamble identifier, means for transmitting a first random access preamble corresponding to the first preamble identifier and a second random access preamble corresponding to the second preamble identifier, and means for receiving a RAR associated with one of the first random access procedure or the second random access procedure based on a preamble identifier indication included in the RAR.

A non-transitory computer-readable medium storing code for wireless communications at a UE is described. The code may include instructions executable by a processor to receive a first control message in a first PDCCH order triggering a first random access procedure, the first control message indicating a first preamble identifier associated with the first random access procedure, receive a second control message in a second PDCCH order triggering a second random access procedure during the first random access procedure, the second control message indicating a second preamble identifier associated with the second random access procedure, where the first preamble identifier is different than the second preamble identifier, transmit a first random access preamble corresponding to the first preamble identifier and a second random access preamble corresponding to the second preamble identifier, and receive a RAR associated with one of the first random access procedure or the second random access procedure based on a preamble identifier indication included in the RAR.

Some examples of the method, apparatuses, and non-transitory computer-readable medium described herein may further include operations, features, means, or instructions for monitoring for the RAR associated the first random access procedure and monitoring for the RAR associated with the second random access procedure.

In some examples of the method, apparatuses, and non-transitory computer-readable medium described herein, receiving the RAR may include operations, features, means, or instructions for receiving the RAR associated with the first random access procedure based on the preamble identifier indication corresponding to the first preamble identifier and receiving the RAR associated with the second random access procedure based on the preamble identifier indication corresponding to the second preamble identifier.

Some examples of the method, apparatuses, and non-transitory computer-readable medium described herein may further include operations, features, means, or instructions for receiving a PDSCH associated with the first random access procedure or the second random access procedure based on the preamble identifier indication included in the RAR, where the RAR includes the PDSCH.

In some examples of the method, apparatuses, and non-transitory computer-readable medium described herein, receiving the first control message and the second control message may include operations, features, means, or instructions for receiving the first PDCCH order from a first network entity and receiving the second PDCCH order from a second network entity different from the first network entity.

A method for wireless communications at a UE is described. The method may include transmitting a first random access preamble corresponding to a first preamble identifier as part of a first random access procedure, transmitting, during the first random access procedure, a second random access preamble corresponding to a second preamble identifier, the second random access preamble associated with a second random access procedure, and receiving a RAR associated with one of the first random access procedure or the second random access procedure based on an indication of a timing advance group in the RAR.

An apparatus for wireless communications at a UE is described. The apparatus may include a processor, memory coupled with the processor, and instructions stored in the memory. The instructions may be executable by the processor to cause the apparatus to transmit a first random access preamble corresponding to a first preamble identifier as part of a first random access procedure, transmit, during the first random access procedure, a second random access preamble corresponding to a second preamble identifier, the second random access preamble associated with a second random access procedure, and receive a RAR associated with one of the first random access procedure or the second random access procedure based on an indication of a timing advance group in the RAR.

Another apparatus for wireless communications at a UE is described. The apparatus may include means for transmitting a first random access preamble corresponding to a first preamble identifier as part of a first random access procedure, means for transmitting, during the first random access procedure, a second random access preamble corresponding to a second preamble identifier, the second random access preamble associated with a second random access procedure, and means for receiving a RAR associated with one of the first random access procedure or the second random access procedure based on an indication of a timing advance group in the RAR.

A non-transitory computer-readable medium storing code for wireless communications at a UE is described. The code may include instructions executable by a processor to transmit a first random access preamble corresponding to a first preamble identifier as part of a first random access procedure, transmit, during the first random access procedure, a second random access preamble corresponding to a second preamble identifier, the second random access preamble associated with a second random access procedure, and receive a RAR associated with one of the first random access procedure or the second random access procedure based on an indication of a timing advance group in the RAR.

Some examples of the method, apparatuses, and non-transitory computer-readable medium described herein may further include operations, features, means, or instructions for monitoring for the RAR associated with the first random access procedure and monitoring for the RAR associated with the second random access procedure.

Some examples of the method, apparatuses, and non-transitory computer-readable medium described herein may further include operations, features, means, or instructions for receiving a first control message in a first PDCCH order associated with the first random access procedure, the first control message indicating the first preamble identifier and receiving a second control message in a second PDCCH order associated with the second random access procedure, the second control message indicating the second preamble identifier.

In some examples of the method, apparatuses, and non-transitory computer-readable medium described herein, receiving the first control message and the second control message may include operations, features, means, or instructions for receiving the first control message in the first PDCCH order from a first network entity and receiving the second control message in the second PDCCH order from a second network entity different from the first network entity.

Some examples of the method, apparatuses, and non-transitory computer-readable medium described herein may further include operations, features, means, or instructions for receiving a PDSCH associated with the first random access procedure or the second random access procedure based on the indication of the timing advance group included in the RAR, where the RAR includes the PDSCH.

In some examples of the method, apparatuses, and non-transitory computer-readable medium described herein, receiving the RAR may include operations, features, means, or instructions for receiving a timing advance group identifier in a field of the RAR, where the indication of the timing advance group may be based on the timing advance group identifier.

In some examples of the method, apparatuses, and non-transitory computer-readable medium described herein, receiving the RAR may include operations, features, means, or instructions for receiving the indication of the timing advance group in one or more fields of the RAR, where the one or more fields includes a reserved field and a CSI request field.

In some examples of the method, apparatuses, and non-transitory computer-readable medium described herein, receiving the RAR may include operations, features, means, or instructions for receiving a PDCCH scrambled by a random access temporary identifier, where the indication of the timing advance group may be based on the random access temporary identifier and where the RAR includes the PDCCH scrambled by the random access temporary identifier.

In some examples of the method, apparatuses, and non-transitory computer-readable medium described herein, receiving the PDCCH scrambled by the random access temporary identifier may include operations, features, means, or instructions for receiving an indication of a CORESET pool index in the PDCCH scrambled by the random access temporary identifier, where the CORESET pool index may be based on the random access temporary identifier and may be associated with the first random access procedure or the second random access procedure.

In some examples of the method, apparatuses, and non-transitory computer-readable medium described herein, receiving the PDCCH scrambled by the random access temporary identifier may include operations, features, means, or instructions for receiving an indication of a timing advance group identifier in the PDCCH scrambled by the random access temporary identifier, where the timing advance group identifier may be based on the random access temporary identifier and may be associated with the first random access procedure or the second random access procedure.

In some examples of the method, apparatuses, and non-transitory computer-readable medium described herein, receiving the RAR may include operations, features, means, or instructions for receiving the indication of the timing advance group in one or more reserved bits in a PDCCH scrambled by a random access temporary identifier, where the RAR includes the PDCCH.

In some examples of the method, apparatuses, and non-transitory computer-readable medium described herein, receiving the RAR may include operations, features, means, or instructions for receiving an indication of a CORESET pool index in one or more reserved bits in a PDCCH scrambled by a random access temporary identifier, where the CORESET pool index may be associated with the timing advance group and where the RAR includes the PDCCH.

A method for wireless communications at a UE is described. The method may include receiving a radio resource control message indicating that a component carrier is associated with both a first timing advance group and a second timing advance group, receiving, via a first PDCCH order, a first control message triggering a first random access procedure, where the first PDCCH order is associated with a first CORESET pool index, receiving, via a second PDCCH order and during the first random access procedure, a second control message triggering a second random access procedure, where the second PDCCH order is associated with a second CORESET pool index, transmitting a first random access preamble via a first random access occasion on the component carrier and a second random access preamble via a second random access occasion on the component carrier, and receiving a RAR that includes an indication of a timing advance group, where the RAR is associated with the first random access procedure based on the timing advance group corresponding to the first CORESET pool index or the first random access occasion, or the RAR is associated with the second random access procedure based on the timing advance group corresponding to the second CORESET pool index or the second random access occasion.

An apparatus for wireless communications at a UE is described. The apparatus may include a processor, memory coupled with the processor, and instructions stored in the memory. The instructions may be executable by the processor to cause the apparatus to receive a radio resource control message indicating that a component carrier is associated with both a first timing advance group and a second timing advance group, receive, via a first PDCCH order, a first control message triggering a first random access procedure, where the first PDCCH order is associated with a first CORESET pool index, receive, via a second PDCCH order and during the first random access procedure, a second control message triggering a second random access procedure, where the second PDCCH order is associated with a second CORESET pool index, transmit a first random access preamble via a first random access occasion on the component carrier and a second random access preamble via a second random access occasion on the component carrier, and receive a RAR that includes an indication of a timing advance group, where the RAR is associated with the first random access procedure based on the timing advance group corresponding to the first CORESET pool index or the first random access occasion, or the RAR is associated with the second random access procedure based on the timing advance group corresponding to the second CORESET pool index or the second random access occasion.

Another apparatus for wireless communications at a UE is described. The apparatus may include means for receiving a radio resource control message indicating that a component carrier is associated with both a first timing advance group and a second timing advance group, means for receiving, via a first PDCCH order, a first control message triggering a first random access procedure, where the first PDCCH order is associated with a first CORESET pool index, means for receiving, via a second PDCCH order and during the first random access procedure, a second control message triggering a second random access procedure, where the second PDCCH order is associated with a second CORESET pool index, means for transmitting a first random access preamble via a first random access occasion on the component carrier and a second random access preamble via a second random access occasion on the component carrier, and means for receiving a RAR that includes an indication of a timing advance group, where the RAR is associated with the first random access procedure based on the timing advance group corresponding to the first CORESET pool index or the first random access occasion, or the RAR is associated with the second random access procedure based on the timing advance group corresponding to the second CORESET pool index or the second random access occasion.

A non-transitory computer-readable medium storing code for wireless communications at a UE is described. The code may include instructions executable by a processor to receive a radio resource control message indicating that a component carrier is associated with both a first timing advance group and a second timing advance group, receive, via a first PDCCH order, a first control message triggering a first random access procedure, where the first PDCCH order is associated with a first CORESET pool index, receive, via a second PDCCH order and during the first random access procedure, a second control message triggering a second random access procedure, where the second PDCCH order is associated with a second CORESET pool index, transmit a first random access preamble via a first random access occasion on the component carrier and a second random access preamble via a second random access occasion on the component carrier, and receive a RAR that includes an indication of a timing advance group, where the RAR is associated with the first random access procedure based on the timing advance group corresponding to the first CORESET pool index or the first random access occasion, or the RAR is associated with the second random access procedure based on the timing advance group corresponding to the second CORESET pool index or the second random access occasion.

Some examples of the method, apparatuses, and non-transitory computer-readable medium described herein may further include operations, features, means, or instructions for determining the first random access procedure may be associated with the timing advance group based on the first PDCCH order being associated with the first CORESET pool index and the first CORESET pool index being associated with the timing advance group, or the first random access occasion being associated with the timing advance group and determining, the second random access procedure may be associated with the timing advance group based on the second PDCCH order being associated with the second CORESET pool index and the second CORESET pool index being associated with the timing advance group, or the second random access occasion being associated with the timing advance group.

Some examples of the method, apparatuses, and non-transitory computer-readable medium described herein may further include operations, features, means, or instructions for monitoring for the RAR associated with the first random access procedure and monitoring for the RAR associated with the second random access procedure.

A method for wireless communications at a network entity is described. The method may include receiving a first control message indicating a first random access procedure for a UE, receiving a second control message indicating a second random access procedure during the first random access procedure, the second random access procedure for the UE, and transmitting, to the UE, a RAR associated with one of the first random access procedure or the second random access procedure, the RAR including an indication of one of the first random access procedure or the second random access procedure.

An apparatus for wireless communications at a network entity is described. The apparatus may include a processor, memory coupled with the processor, and instructions stored in the memory. The instructions may be executable by the processor to cause the apparatus to receive a first control message indicating a first random access procedure for a UE, receive a second control message indicating a second random access procedure during the first random access procedure, the second random access procedure for the UE, and transmit, to the UE, a RAR associated with one of the first random access procedure or the second random access procedure, the RAR including an indication of one of the first random access procedure or the second random access procedure.

Another apparatus for wireless communications at a network entity is described. The apparatus may include means for receiving a first control message indicating a first random access procedure for a UE, means for receiving a second control message indicating a second random access procedure during the first random access procedure, the second random access procedure for the UE, and means for transmitting, to the UE, a RAR associated with one of the first random access procedure or the second random access procedure, the RAR including an indication of one of the first random access procedure or the second random access procedure.

A non-transitory computer-readable medium storing code for wireless communications at a network entity is described. The code may include instructions executable by a processor to receive a first control message indicating a first random access procedure for a UE, receive a second control message indicating a second random access procedure during the first random access procedure, the second random access procedure for the UE, and transmit, to the UE, a RAR associated with one of the first random access procedure or the second random access procedure, the RAR including an indication of one of the first random access procedure or the second random access procedure.

In some examples of the method, apparatuses, and non-transitory computer-readable medium described herein, transmitting the RAR may include operations, features, means, or instructions for transmitting a preamble identifier associated with the first random access procedure or the second random access procedure, where the indication included in the RAR may be based on the preamble identifier.

In some examples of the method, apparatuses, and non-transitory computer-readable medium described herein, transmitting the RAR may include operations, features, means, or instructions for transmitting an indication of a timing advance group associated with the first random access procedure or the second random access procedure, where the indication included in the RAR may be the indication of the timing advance group.

In some examples of the method, apparatuses, and non-transitory computer-readable medium described herein, transmitting the indication of the timing advance group may include operations, features, means, or instructions for transmitting a timing advance group identifier in a field of the RAR, where the indication of the timing advance group may be based on the timing advance group identifier.

In some examples of the method, apparatuses, and non-transitory computer-readable medium described herein, transmitting the indication of the timing advance group may include operations, features, means, or instructions for transmitting the indication of the timing advance group in one or more fields of the RAR, where the one or more fields includes a reserved field, a CSI request field, or both.

In some examples of the method, apparatuses, and non-transitory computer-readable medium described herein, transmitting the indication of the timing advance group may include operations, features, means, or instructions for transmitting a PDCCH scrambled by a random access temporary identifier, where the indication of the timing advance group may be based on the random access temporary identifier and where the RAR includes the PDCCH scrambled by the random access temporary identifier.

In some examples of the method, apparatuses, and non-transitory computer-readable medium described herein, transmitting the PDCCH scrambled by the random access temporary identifier may include operations, features, means, or instructions for transmitting an indication of a CORESET pool index in the PDCCH scrambled by the random access temporary identifier, where the CORESET pool index may be based on the random access temporary identifier and may be associated with the first random access procedure or the second random access procedure.

In some examples of the method, apparatuses, and non-transitory computer-readable medium described herein, transmitting the PDCCH scrambled by the random access temporary identifier may include operations, features, means, or instructions for transmitting an indication of a timing advance group identifier in the PDCCH scrambled by the random access temporary identifier, where the timing advance group identifier may be based on the random access temporary identifier and may be associated with the first random access procedure or the second random access procedure.

In some examples of the method, apparatuses, and non-transitory computer-readable medium described herein, transmitting the indication of the timing advance group may include operations, features, means, or instructions for transmitting the indication of the timing advance group in one or more reserved bits in a PDCCH scrambled by a random access temporary identifier, where the RAR includes the PDCCH.

In some examples of the method, apparatuses, and non-transitory computer-readable medium described herein, transmitting the RAR may include operations, features, means, or instructions for transmitting an indication of a CORESET pool index in one or more bits in a PDCCH scrambled by a random access temporary identifier, where the RAR includes the PDCCH.

### BRIEF DESCRIPTION OF THE DRAWINGS

FIG. 1 illustrates an example of a wireless communications system that supports RAR enhancements for multiple RACH procedures in accordance with one or more aspects of the present disclosure.

FIG. 2 illustrates an example of a wireless communications system that supports RAR enhancements for multiple RACH procedures in accordance with one or more aspects of the present disclosure.

FIG. 3 illustrates an example of a wireless communications system that supports RAR enhancements for multiple RACH procedures in accordance with one or more aspects of the present disclosure.

FIGS. 4A and 4B illustrates examples of wireless communications systems that supports RAR enhancements for multiple RACH procedures in accordance with one or more aspects of the present disclosure.

FIG. 5 illustrates an example of a process flow that supports RAR enhancements for multiple RACH procedures in accordance with one or more aspects of the present disclosure.

FIGS. 6 and 7 show block diagrams of devices that support RAR enhancements for multiple RACH procedures in accordance with one or more aspects of the present disclosure.

FIG. 8 shows a block diagram of a communications manager that supports RAR enhancements for multiple RACH procedures in accordance with one or more aspects of the present disclosure.

FIG. 9 shows a diagram of a system including a device that supports RAR enhancements for multiple RACH procedures in accordance with one or more aspects of the present disclosure.

FIGS. 10 and 11 show block diagrams of devices that support RAR enhancements for multiple RACH procedures in accordance with one or more aspects of the present disclosure.

FIG. 12 shows a block diagram of a communications manager that supports RAR enhancements for multiple RACH procedures in accordance with one or more aspects of the present disclosure.

FIG. 13 shows a diagram of a system including a device that supports RAR enhancements for multiple RACH procedures in accordance with one or more aspects of the present disclosure.

FIGS. 14 through 17 show flowcharts illustrating methods that support RAR enhancements for multiple RACH procedures in accordance with one or more aspects of the present disclosure.

### DETAILED DESCRIPTION

Some wireless communications systems may support random access channel (RACH) procedures. In a RACH procedure, a network entity may transmit a physical downlink control channel (PDCCH) order to a user equipment (UE) allocating or assigning a random access preamble (e.g., physical random access channel (PRACH)) identifier to the UE for a given RACH procedure triggered by the PDCCH order. The UE may transmit a random access preamble associated with the random access preamble identifier (e.g., Physical RACH (PRACH) preamble). The UE may monitor for a random access response (RAR) from the network (e.g., another network entity) and the network may transmit a RAR including an indication of a random access preamble identifier (RAPID). The RAR may include a PDCCH scrambled by a random access temporary identifier (e.g., a random access radio network temporary identifier (RA-RNTI)) and a physical downlink shared channel (PDSCH). The UE may identify that the RAPID in the RAR corresponds to the random access preamble identifier associated with the random access preamble transmitted by the UE and may forward the PDSCH to a higher layer at the UE (e.g., from a physical layer to a medium access control (MAC) layer), completing the RACH procedure. In some cases, however, a second or subsequent RACH procedure may be triggered at a UE while a current RACH procedure is already ongoing at the UE. In such cases, the UE may determine whether to continue the current RACH procedure and ignore the second RACH procedure or stop the current RACH procedure and start the second RACH procedure. That is, the UE may not be capable of performing multiple RACH procedures at the same time (e.g., in parallel).

Techniques described herein may support a UE performing multiple random access (e.g., RACH) procedures in parallel. In some cases, a UE may receive multiple PDCCH orders, each triggering a RACH procedure and each indicating a random access preamble identifier. In some cases, the random access preamble identifiers in each PDCCH order may be the same while in some other cases they may be different. The UE may transmit multiple random access preambles in response to the multiple PDCCH orders, where each random access preamble is associated with a random access preamble identifier allocated by a respective PDCCH order. The UE may then monitor for RARs in response to the random access preambles and may receive at least one RAR associated with a random access preamble identifier indicated by one of the PDCCH orders.

In some cases (e.g., when each PDCCH order indicates a unique random access preamble identifier), the UE may determine which RACH procedure corresponds to the RAR based on a RAPID in the RAR. For example, the UE may determine that the RAR corresponds to a respective RACH procedure based on the RAPID in the RAR corresponding to a random access preamble identifier associated with the respective RACH procedure.

Additionally or alternatively, the UE may determine which RACH procedure corresponds to the RAR based on an indication of a timing advance group. For example, the UE may receive a RAR including an indication of a timing advance group associated with a first component carrier and the UE may determine that the RAR is associated with a RACH procedure which is also associated with the component carrier. In some cases, the timing advance group may be indicated by a timing advance group indicator field in the RAR, a combination of a reserved field and a channel state information (CSI) request field in the RAR, a random access temporary identifier used to scramble the PDCCH in the RAR, one or more reserved bits in the RAR, or a control resource set (CORESET) pool index associated with the RAR.

Additionally or alternatively, the UE may determine a timing advance group is associated with a RACH procedure based on a CORESET pool index associated with the PDCCH order or a RACH occasion associated with the random access preamble. For example, a network entity transmit a PDCCH order associated with a CORESET pool index triggering a RACH procedure. The UE may determine that the CORSET pool index is associated with a timing advance group and thus determine the timing advance group is associated with the RACH procedure triggered by the PDCCH order associated with the CORESET pool index.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to RAR enhancements for multiple RACH procedures.

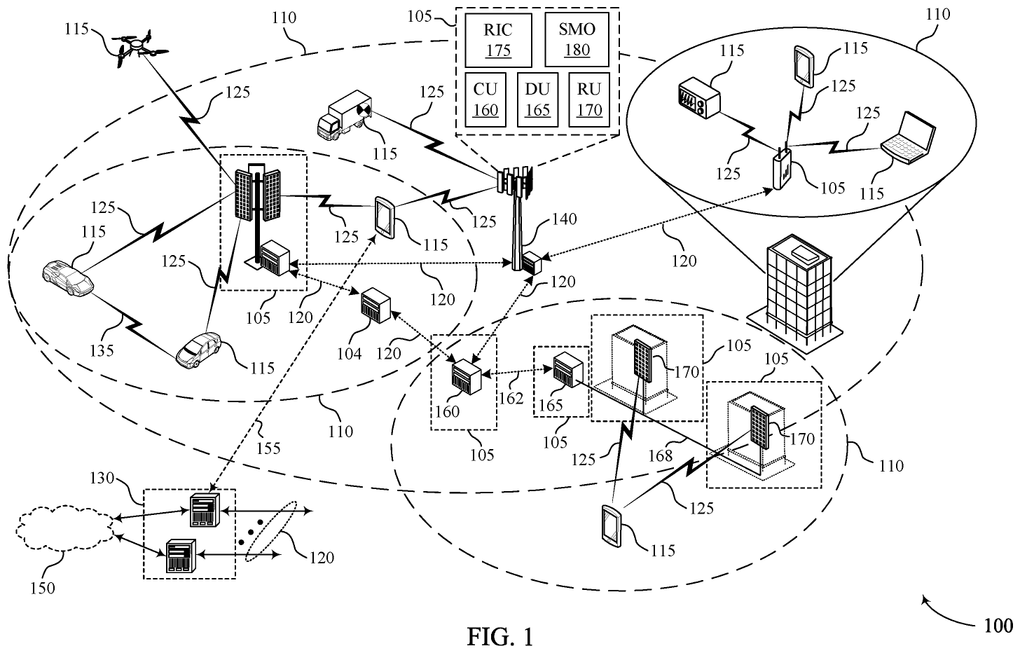

FIG. 1 illustrates an example of a wireless communications system 100 that supports RAR enhancements for multiple RACH procedures in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support RAR enhancements for multiple RACH procedures as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM

(DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support RAR enhancements for multiple RACH procedures. For example, a UE 115 may receive multiple PDCCH orders, such as a first PDCCH order and a second PDCCH order, each triggering a respective RACH procedure and each indicating a random access preamble identifier for the respective RACH procedure. The UE 115 may transmit a random access preamble in response to each PDCCH order and each random access preamble may be associated with a random access preamble identifier allocated in a respective PDCCH order. In some cases, the UE 115 may receive a RAR and determine the RAR is associated with a respective RACH procedure based on a random access preamble identifier indication (e.g., a RAPID) in the RAR. For example, a RAR may include a RAPID that corresponds to a random access preamble identifier associated with a random access preamble transmitted by the UE 115. Thus, the UE 115 may determine the RAR is associated with the random access preamble and, because the random access preamble is associated with a PDCCH order which triggered a RACH procedure, the UE may determine the RAR is associated with the RACH procedure.

Additionally or alternatively, the UE 115 may determine which RACH procedure corresponds to a RAR based on an indication of a timing advance group. In some cases, the timing advance group may be indicated by a timing advance group indicator field in the RAR, a combination of a reserved field and a CSI request field in the RAR, a random access temporary identifier used to scramble the PDCCH in the RAR, one or more reserved bits in the RAR, or a control resource set (CORESET) pool index associated with the RAR. Additionally, the UE may determine a timing advance group is associated with a RACH procedure based on a CORESET pool index associated with the PDCCH order or a RACH occasion associated with the random access preamble.

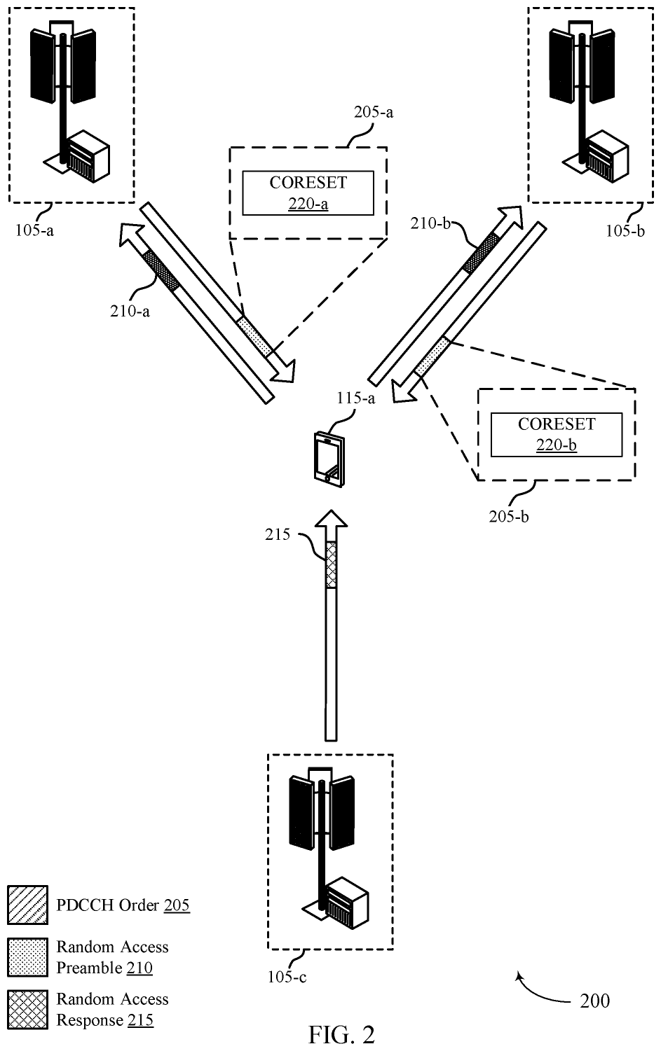

FIG. 2 illustrates an example of a wireless communications system 200 that supports RAR enhancements for multiple RACH procedures in accordance with one or more aspects of the present disclosure. The wireless communications system 200 may implement or be implemented by aspects of the wireless communications system 100. For example, the wireless communications system 200 may include a network entity 105-a, a network entity 105-b, a network entity 105-c, and a UE 115-a. The UE 115-a may represent an example of a UE 115 as described herein, including with reference to FIG. 1. The network entity 105-a, the network entity 105-b, and the network entity 105-c may represent examples of a network entity 105 as described herein, including with reference to FIG. 1. In some case, the UE 115-a may receive multiple PDCCH orders 205 triggering multiple RACH procedures and may perform the multiple random access procedures at the same time (e.g., in parallel).

Some wireless communications systems may support random access procedures (e.g., RACH procedures). For example, a network entity 105 may transmit a PDCCH order 205 to a UE 115 including an indication of a random access preamble identifier (e.g., preamble index) associated with a first RACH procedure. In response, the UE 115 may transmit a random access preamble 210 (e.g., message (MSG) 1) corresponding to the random access preamble identifier associated with the first RACH procedure and monitor for a response (e.g., a RAR 215) during a response window (e.g., a duration of time that may be configured via higher layer signaling, preconfigured, or dynamically indicated to the UE 115-a for a given RACH procedure).

In some cases, the UE 115 may fail to receive a RAR 215 (e.g., MSG 2) including a random access preamble identifier indication (e.g., RAPID) that corresponds to the random access preamble identifier associated with the random access preamble 210. In such cases, the UE 115 may consider the random access reception unsuccessful and increment a preamble transmission counter by one. In some cases, prior to retransmission of the PDCCH order 205 (e.g., due to the random access reception failure) the UE 115 may change a spatial domain filter at the UE 115 and may suspend a power ramping counter associated with the first RACH procedure. In some other cases, prior to retransmission of the PDCCH order 205, the UE 115 may refrain from changing the spatial domain filter and may increment the power ramping counter by one. In some cases, the value of the preamble transmission counter may exceed a threshold (e.g., preamble transmission counter maximum plus 1) and the UE 115 may consider the first RACH procedure unsuccessful.

In some examples, the UE 115 may receive a RAR 215 including an RAPID (e.g., in a MAC sub-packet data unit (subPDU)) corresponding to the random access preamble identifier associated with the random access preamble 210. Additionally, the RAR 215 may include a PDSCH and a PDCCH scrambled by a random access radio network temporary identifier (RA-RNTI). In such cases, the UE 115 may decode the RAR 215 (e.g., the received transport block) and forward the PDSCH to a higher layer at the UE 115 (e.g., from the physical layer to the MAC layer). Additionally, the UE 115 may determine the RAR 215 is successful (e.g., the first RACH procedure is successful) and apply a received timing advance command (e.g., from the RAR 215) for the network entity 105 (e.g., the serving cell where the random access preamble 210 is transmitted).

In some cases, the UE 115 may receive a second PDCCH order 205 triggering a second RACH procedure while the first RACH procedure is ongoing (e.g., during the first RACH procedure). In such cases, the UE 115 may determine whether to stop the first RACH procedure and perform (e.g., start) the second RACH procedure or ignore the second RACH procedure and continue performing the first RACH procedure. That is, the UE 115 may not be capable of performing the first RACH procedure and the second RACH procedure (e.g., multiple RACH procedures) in parallel.

Techniques described herein may support RAR enhancements for multiple RACH procedures. In some cases, a UE 115-a may receive a PDCCH order 205-a (e.g., a control message) from a network entity 105-a triggering a first RACH procedure (e.g., a random access procedure). Further, the PDCCH order 205-a may indicate a first random access preamble identifier (e.g., physical random access channel (PRACH) preamble index) associated with the first RACH procedure. Additionally, the UE 115-a may receive a PDCCH order 205-b from a network entity 105-b triggering a second RACH procedure (e.g., during the first random access procedure). Further, the PDCCH order 205-b may indicate a second random access preamble identifier associated with the second RACH procedure. In some cases, the first random access preamble identifier and the second random access preamble identifier may be the same, while in other cases the first random access preamble identifier and the second random access preamble identifier maybe different (e.g., unique).

In some cases, the UE 115-a may transmit a random access preamble 210-a (e.g., a PRACH preamble) to the network entity 105-a corresponding to the first random access preamble identifier and a random access preamble 210-b to the network entity 105-b corresponding to the second random access preamble identifier. Additionally, the UE 115-a may monitor for a RAR 215 from a network, such as a network entity 105-c, during a response window (e.g., a configured monitoring window). In some cases, the network entity 105-c may transmit the RAR 215 to the UE 115-a during the response window and the UE 115-a may determine which RACH procedure (e.g., the first RACH procedure or the second RACH procedure) the RAR 215 is associated with (e.g., corresponds to) based on an indication in the RAR 215.

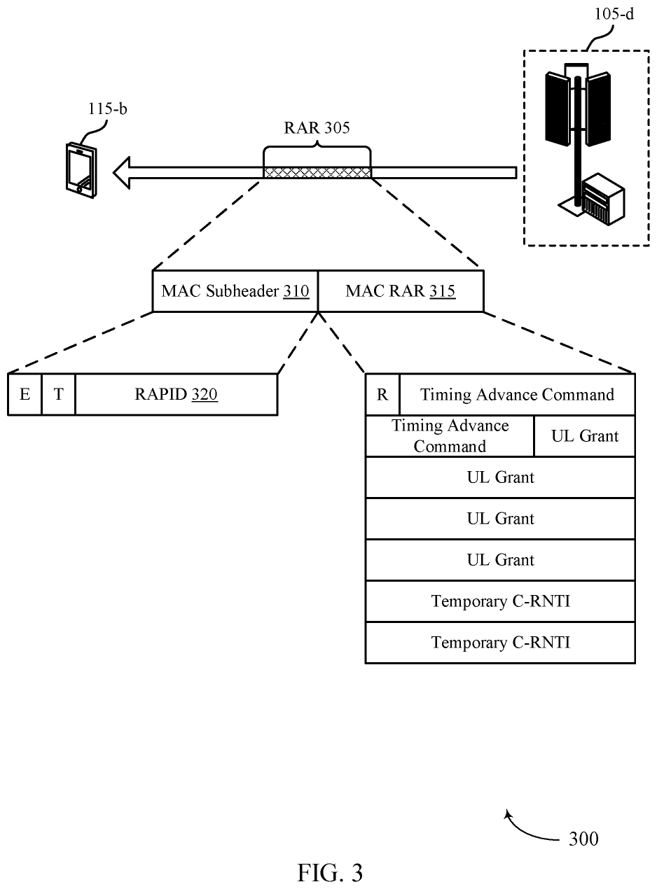

In some cases (e.g., when the first random access preamble identifier and the second random access preamble identifier are different), the UE 115-a may determine which random RACH the RAR 215 corresponds to based on a RAPID (e.g., a random access preamble identifier indication) in the RAR 215, as described with respect to FIG. 3. For example, the RAR 215 may include a RAPID corresponding to the first random access preamble identifier and the UE 115-a may determine that the RAR 215 is associated with the first RACH procedure based on the RAPID corresponding to the first random access preamble. In another example, the RAR 215 may include RAPID corresponding to the second random access preamble identifier and the UE 115-a may determine that the RAR 215 is associated with the second RACH procedure based on the RAPID corresponding to the second random access preamble. In some cases, the UE 115-a may be configured such that the UE 115-a does not expect to receive multiple PDCCH orders 205 indicating the same random access preamble identifier (e.g., while a RACH procedure is already ongoing).

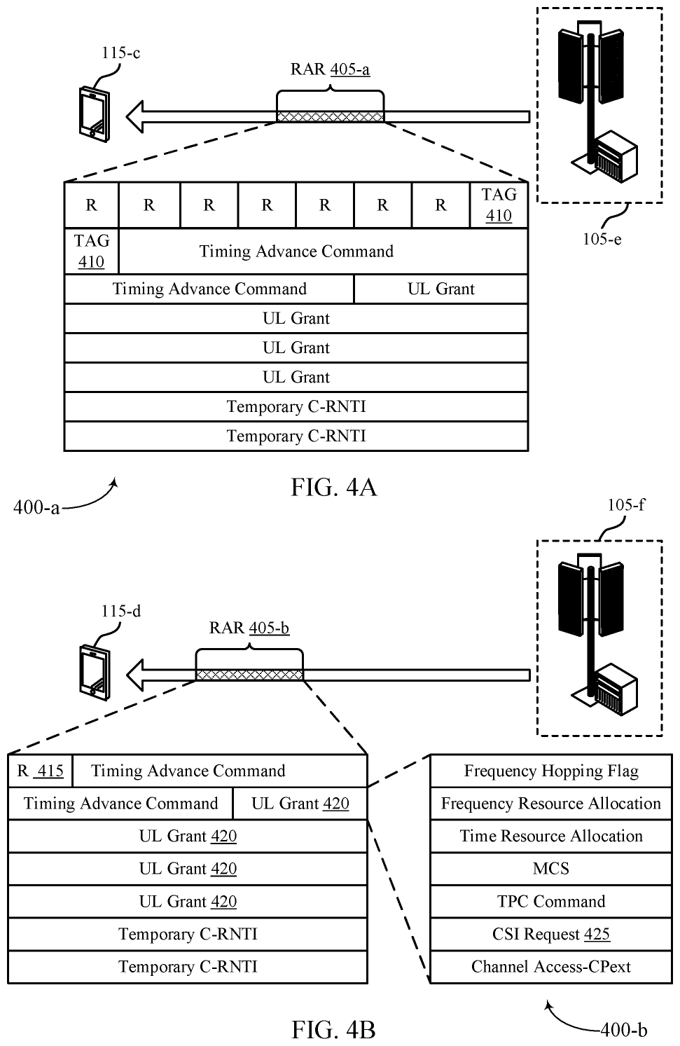

Additionally or alternatively, the UE 115-a may determine which RACH procedure the RAR 215 corresponds to based on an indication of a timing advance group in the RAR 215, as described with respect to FIGS. 4A and 4B. For example, the RAR 215 may include an indication of a first timing advance group and the UE 115-a may determine that the RAR 215 is associated with the first RACH procedure based on the indication of the first timing advance group. In another example, the RAR 215 may include an indication of the second timing advance group and the UE 115-a may determine that the RAR 215 is associated with the second RACH procedure based on the indication of the second timing advance group.

Additionally, the UE 115-a may determine a timing advance group is associated with a respective RACH procedure based on a CORESET pool index of a CORESET 220 where a PDCCH order 205 is received. For example, a RACH procedure may be associated with a timing advance group that is further associated with a CORESET pool index of a CORESET 220 where a PDCCH order 205 that triggered the RACH procedure is received. As an illustrative example, the UE 115-a may receive the PDCCH order 205-a triggering a first RACH procedure via a CORESET 220-a which corresponds to a first CORESET pool index associated with a first timing advance group. Thus, the UE 115-a may determine the first RACH procedure is associated with the first timing advance group. In another example, the UE 115-a may receive the PDCCH order 205-b triggering a second RACH procedure via a CORESET 220-b which corresponds to a second CORESET pool index associated with a second timing advance group. Thus, the UE 115-a may determine the second RACH procedure is associated with the second timing advance group.

Additionally or alternatively, the UE 115-a may determine a timing advance group is associated with a respective RACH procedure based on a timing advance group of a network entity 105 ((e.g., or component carrier or TRP) receiving a random access preamble 210. In some cases (e.g., when a network entity 105 is associated or configured with a single timing advance group), the UE 115-a may determine a RACH procedure is associated with a timing advance group further associated with the network entity 105 where a random access preamble 210 is received. For example, the network entity 105-a may be associated with a first timing advance group. Additionally, the network entity 105-a may transmit a PDCCH order 205-a triggering a first RACH procedure. The UE 115-a may transmit a random access preamble 210-a to the network entity 105-a during the first RACH procedure and the UE 115-a may determine the first RACH procedure is associated with the first timing advance group based on the network entity 105-a being associated with the first timing advance group.

In some other cases (e.g., when a network entity 105 is associated or configured with multiple timing advance groups), the UE 115-a may determine a RACH procedure is associated with a timing advance group based on a CORESET pool index of a CORESET 220 where a PDCCH order 205 is received or a RACH occasion (e.g., random access occasion) indicated in the PDCCH order 205 is received. For example, as described previously, a CORESET pool index of a CORESET 220 may be associated with a timing advance group and a network entity 105 may trigger a RACH procedure via a PDCCH order 205 associated with the same CORESET pool index of the CORESET 220. Therefore, the RACH procedure may be associated with the timing advance group. Alternatively, the UE 115-a may determine a RACH procedure is associated with a timing advance group based on a RACH occasion, which may also be referred to as a random access occasion, (e.g., or synchronization signal block (SSB) index) indicated in a PDCCH order 205.

FIG. 3 illustrates an example of a wireless communications system 300 that supports RAR enhancements for multiple RACH procedures in accordance with one or more aspects of the present disclosure. The wireless communications system 300 may implement or be implemented by aspects of the wireless communications system 100 and the wireless communications system 200. For example, the wireless communications system 300 may include a network entity 105-d and a UE 115-b. The UE 115-b may represent an example of a UE 115 as described herein, including with reference to FIG. 1. The network entity 105-d may represent an example of a network entity 105 as described herein, including with reference to FIG. 1. In some case, the UE 115-b may receive, from the network entity 105-d, a RAR 305 including a random access preamble identifier indication (e.g., a RAPID 320) and may determine a random access procedure associated with the RAR 305 based on the indication.

In some cases, a UE 115-b may receive multiple PDCCH orders each triggering a respective RACH procedure. In some cases, each PDCCH order may allocate, to the UE 115-b, a random access preamble identifier (e.g., preamble index) associated with the respective RACH procedure. Additionally, the UE 115-b may transmit multiple random access preambles (e.g., PRACH preambles), where each random access preamble corresponds to a random access preamble identifier indicated in a PDCCH order. For example, the UE 115-b may receive a first PDCCH order allocating a first random access preamble identifier associated with a first RACH procedure and a second PDCCH order allocating a second random access preamble identifier associated with a second RACH procedure. As such, the UE 115-b may transmit a first random access preamble corresponding to the first random access preamble identifier and a second random access preamble corresponding to the second random access preamble identifier. Additionally, the UE 115-b may receive a RAR 305 in response to the first random access preamble or the second random access preamble.

In some cases, the UE 115-b may be configured such that the UE 115-b may not expect to receive multiple PDCCH orders allocating (e.g., indicating) the same random access preamble identifier (e.g., for parallel RACH procedures). For example, while the UE 115-b performs a first RACH procedure associated with a first PDCCH order allocating a first random access preamble identifier, the UE 115-b may not expect to receive a second PDCCH order associated with a second RACH procedure allocating a second random access preamble identifier that is the same as the first random access preamble identifier. As such, a given random access preamble identifier may be associated with a single RACH procedure while the UE 115-b performs multiple RACH procedures in parallel (e.g., multiple RACH procedures may be supported when the PDCCH orders triggering the RACH procedures indicate different random access preamble identifiers).

In such cases, the UE 115-b may determine a RAR 305 is associated with a respective RACH procedure based on an preamble identifier indication (e.g., RAPID 320) in the RAR 305. For example, the UE 115-b may receive the RAR 305 including a MAC subheader 310 and a MAC RAR 315. The MAC RAR 315 may include one or more reserved bit fields, a timing advance command field, an uplink grant field (indicated by UL grant), a temporary cell radio network temporary identifier (TC-RNTI) field, or any combination thereof. Additionally the MAC subheader 310 may include an extension (E) field, a type field (T), and a RAPID 320 field. In some cases, the RAPID 320 may correspond to a random access preamble identifier associated with a random access preamble transmitted by the UE 115-b. In such cases, the UE 115-b may determine that the RAR 305, and more specifically a PDSCH of the RAR 305, corresponds to a RACH procedure associated with the RAPID 320.

For example, the UE 115-b may receive a first PDCCH order indicating a first random access preamble identifier associated with a first RACH procedure and a second PDCCH order indicating a second random access preamble identifier associated with a second RACH procedure (e.g., triggered during the first RACH procedure), where the first random access preamble identifier and the second random access preamble identifier are different. The UE 115-b may transmit a first random access preamble corresponding to the first random access preamble identifier and a second random access preamble corresponding to the second random access preamble identifier. The UE 115-b may then receive a RAR 305 including a RAPID 320. In a first example, the RAPID 320 may correspond to (e.g., indicate) the first random access preamble identifier and the UE 115-b may determine the RAR 305 corresponds to the first RACH procedure based on the RAPID 320. In a second example, the RAPID 320 may correspond to the second random access preamble identifier and the UE 115-b may determine the RAR 305 corresponds to the second random RACH based on the RAPID 320.

FIG. 4A illustrates an example of a wireless communications system 400-a that supports RAR enhancements for multiple RACH procedures in accordance with one or more aspects of the present disclosure. The wireless communications system 400-a may implement or be implemented by aspects of the wireless communications system 100, the wireless communications system 200, and the wireless communications system 300. For example, the wireless communications system 400-a may include a network entity 105-e and a UE 115-c. The UE 115-c may represent an example of a UE 115 as described herein, including with reference to FIG. 1. The network entity 105-e may represent an example of a network entity 105 as described herein, including with reference to FIG. 1. In some case, the UE 115-c may receive, from the network entity 105-e, a RAR 405-a including an indication of a timing advance group and may determine a RACH procedure associated with the RAR 405-a based on the indication of the timing advance group.

In some cases, a UE 115-c may receive multiple PDCCH orders each triggering a respective RACH procedure. In some cases, each PDCCH order may allocate, to the UE 115-c, a random access preamble identifier (e.g., preamble index) associated with the respective RACH procedure. In some cases, the random access preamble identifiers allocated by the multiple PDCCH orders may be the same random access preamble identifier (e.g., the UE 115-c may be configured such that the UE 115-c may support PDCCH orders indicating the same random access preamble for parallel RACH procedures), while in some other cases each random access preamble identifier may be unique (e.g., different). Additionally, the UE 115-c may transmit multiple random access preambles (e.g., PRACH preambles), where each random access preamble corresponds to a random access preamble identifier indicated in a PDCCH order. The network entity 105-e may transmit a RAR 405-a including an indication of a timing advance group, the RAR 405-a being in response to one of the random access preambles transmitted by the UE 115-c.

In some cases, the timing advance group may be indicated by a timing advance group indicator in a field in the RAR 405-a (e.g., a new MAC RAR 405-a). For example, the RAR 405-a may include multiple reserved fields (R), a timing advance command field, an UL grant field, and a temporary C-RNTI field. The RAR 405-a may also include a timing advance group field 410 (e.g., indicated by TAG) which includes a timing advance group indicator for the RAR 405-a. The UE 115-c may identify the timing advance group indicator in the TAG field 410 and determine the RAR 405-a corresponds to a respective RACH procedure based on the timing advance group indicator in the TAG field 410. In some cases, the UE 115-c may determine the relationship between the timing advance group indicated in the RAR 405-a and the respective RACH procedure as described with respect to FIG. 2.

FIG. 4B illustrates an example of a wireless communications system 400-b that supports RAR enhancements for multiple RACH procedures in accordance with one or more aspects of the present disclosure. The wireless communications system 400-b may implement or be implemented by aspects of the wireless communications system 100, the wireless communications system 200, the wireless communications system 300, and the wireless communications system 400-a. For example, the wireless communications system 400-b may include a network entity 105-f and a UE 115-d. The UE 115-d may represent an example of a UE 115 as described herein, including with reference to FIG. 1. The network entity 105-f may represent an example of a network entity 105 as described herein, including with reference to FIG. 1. In some case, the UE 115-d may receive, from the network entity 105-f, a RAR 405-b including an indication of a timing advance group and may determine a RACH procedure associated with the RAR 405-b based on the indication of the timing advance group.

In some cases, a UE 115-d may receive multiple PDCCH orders each triggering a respective RACH procedure. In some cases, each PDCCH order may allocate, to the UE 115-d, a random access preamble identifier (e.g., preamble index) associated with the respective random access procedure. In some cases, the random access preamble identifiers allocated by the multiple PDCCH orders may be the same random access preamble identifier (e.g., the UE 115-d may be configured such that the UE 115-d may support PDCCH orders indicating the same random access preamble for parallel RACH procedures), while in some other cases each random access preamble identifier may be unique (e.g., different). Additionally, the UE 115-d may transmit multiple random access preambles (e.g., PRACH preambles), where each random access preamble corresponds to a random access preamble identifier indicated in a PDCCH order. The network entity 105-f may transmit a RAR 405-b including an indication of a timing advance group, the RAR 405-b being in response to one of the random access preambles transmitted by the UE 115-d.

In some cases, the network entity 105-f may indicate the timing advance group using multiple fields in the RAR 405-b. For example, the RAR 405-b may include a reserved (R) field 415, a timing advance command field, an UL grant field 420, and a temporary C-RNTI field. Further, the UL grant field 420 may include a frequency hopping flag field, a physical uplink shared channel (PUSCH) frequency resource allocation field, a PUSCH time resource allocation field, a modulation and coding scheme (MCS) field, a transmit power control (TPC) command field, a CSI request field 425, and a channel access CPtext field. In some cases, the network entity 105-f may indicate a timing advance group identifier associated with timing advance group corresponding to the RAR 405-b in an R field 415 and a CSI request field 425 in the UL grant field 420 (e.g., a 1-bit R field 415 and a 1-bit CSI request field 425). That is, the RAR 405-b may correspond to a RACH procedure associated with the timing advance group indicated by the R field 415 and the CSI request field 425 (e.g., in combination). In some cases, the UE 115-d may determine the relationship between the timing advance group indicated in the RAR 405-b and the respective RACH procedure as described with respect to FIG. 2.

In some cases, the network entity 105-f may indicate the timing advance group based on the random access temporary identifier (e.g., random access radio network temporary identifier (RA-RNTI)) scrambled for a PDCCH in the RAR 405-b (e.g., which schedules a PDSCH). For example, the random access temporary identifier may be a function of CORESET pool index (e.g., CORESET pool index associated with the PDCCH order). As an illustrative example, the network entity 105-f may determine the random access temporary identifier according to Equation 1:

$$\begin{matrix}RA - RNTI = 1 + {s}_{id} + 14 \times {t}_{id} + 14 \times 80 \times {f}_{id} \\ + 14 \times 80 \times 8 \times ul {carrier}_{id} \\ + 14 \times 80 \times 8 \times 2 \times CORESET pool index\end{matrix} \qquad ( 1 )$$

where s_{id} may correspond to an index of a first symbol (e.g., OFDM symbol) of a random access occasion (e.g., PRACH occasion, 0≤s_{id}<14), t_{id} may correspond to an index of a first slot of the random access occasion in a system frame (e.g., where subcarrier spacing to determine t_{id} may be based on a value of μ, 0≤t_{id}<80), f_{id} may correspond to an index of the random access occasion in the frequency domain (e.g., 0≤f_{id}<8), ul carrier_{id} may correspond to an uplink carrier used for random access preamble transmissions (e.g., 0 for normal uplink carrier and 1 for supplementary uplink carrier), and CORESET pool index may correspond to the CORESET pool index associated with a random access procedure.

As such, the UE 115-d may identify the random access temporary identifier in the RAR 405-b and determine the radio access temporary identifier is associated with a CORESET pool index (e.g., and CORESET) which is further associated with a respective RACH procedure. In another example, the random access temporary identifier may be a function of timing advance group identifier (e.g., a timing advance group associated with a random access procedure). As an illustrative example, the network entity 105-f may determine the random access temporary identifier according to Equation 2:

$$\begin{matrix}RA - RNTI = 1 + {s}_{id} + 14 \times {t}_{id} + 14 \times 80 \times {f}_{id} \\ + 14 \times 80 \times 8 \times ul {carrier}_{id} \\ + 14 \times 80 \times 8 \times 2 \times {TAG}_{id}\end{matrix} \qquad ( 2 )$$

where s_{id} may correspond to an index of a first symbol (e.g., OFDM symbol) of a random access occasion (e.g., PRACH occasion, 0≤s_{id}<14), t_{id} may correspond to an index of a first slot of the random access occasion in a system frame (e.g., where subcarrier spacing to determine t_{id} may be based on a value of μ, 0≤t_{id}<80), f_{id} may correspond to an index of the random access occasion in the frequency domain (e.g., 0≤f_{id}<8), ul carrier_{id} may correspond to an uplink carrier used for random access preamble transmissions (e.g., 0 for normal uplink carrier and 1 for supplementary uplink carrier), and TAG_{id} may correspond to the timing advance group associated with a RACH procedure.

As such, the UE 115-d may identify the random access temporary identifier in the RAR 405-b and determine the radio access temporary identifier is associated with a timing advance group which is further associated with a respective RACH procedure. In some cases, the UE 115-d may determine the relationship between the CORESET pool index or timing advance group indicated by the random access temporary identifier in the RAR 405-b and the respective RACH procedure as described with respect to FIG. 2.

Additionally or alternatively, the network entity 105-f may indicate the timing advance group based on one or more reserved bits (e.g., a new field) in a PDCCH scrambled by the random access temporary identifier. For example, a value (e.g., a 1-bit first value) in the one or more reserved bits may indicate a CORESET pool index. Additionally, the CORESET pool index may be associated with a RACH procedure which may be associated with the RAR 405-b (e.g., a RAR 405-b PDSCH). That is, the UE 115-d may determine the RAR is 405-b is associated with a RACH procedure based on the value associated with a CORESET pool index in the one or more reserved bits. As an illustrative example, a value of 0 may correspond to a CORESET pool index of 0 (e.g., a TRP 1) and a value of 1 may correspond to a CORESET pool index of 1 (e.g., a TRP2). In another example, a value (e.g., 2 bits) in the one or more reserved bits may indicate a timing advance group. That is, each possible bit field value (e.g., 00, 01, 10, 11) may be associated with a timing advance group. Additionally, the timing advance group may be associated with a RACH procedure which may be associated with the RAR 405-b (e.g., a RAR 405-b PDSCH). That is, the UE 115-d may determine the RAR is 405-b is associated with a RACH procedure based on the value associated with a timing advance group in the one or more reserved bits. As an illustrative example, a bit field index of 0 may correspond to a first timing advance group, a bit field index of 1 may correspond to a second timing advance group, a bit field index of 2 may correspond to a third timing advance group, and a bit field index of 3 may correspond to a fourth timing advance group. In some cases, the UE 115-d may determine the relationship between the CORESET pool index or timing advance group indicated via the random access temporary identifier in the RAR 405-b and the respective RACH procedure as described with respect to FIG. 2.

Additionally or alternatively, the UE 115-e may determine the RAR 405-b corresponds to a RACH procedure based on a CORESET pool index of a PDCCH scrambled by a random access temporary identifier in the RAR 405-b (e.g., when a serving cell is configured with two CORESET pool indices and the random access procedure is triggered for the serving cell). In some cases, the UE 115-d may determine the relationship between the CORESET pool index of the PDCCH scrambled by a random access temporary identifier in the RAR 405-b and the respective RACH procedure as described with respect to FIG. 2.

In some cases, the UE 115-d may pass a RAR PDSCH (e.g., PDSCH in the RAR 405-b, transport block) to a higher layer at the UE and may notify the higher layer that the RAR PDSCH is associated with a respective random access procedure.

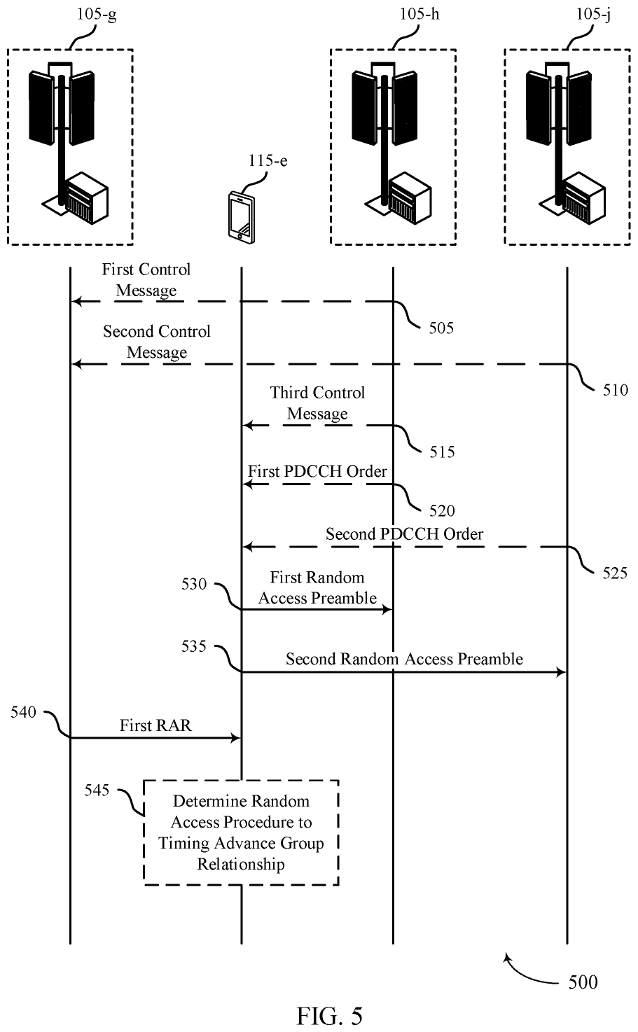

FIG. 5 illustrates an example of a process flow 500 that supports RAR enhancements for multiple RACH procedures in accordance with one or more aspects of the present disclosure. The process flow 500 may implement or be implemented by aspects of the wireless communications system 100, the wireless communications system 200, the wireless communications system 300, and the wireless communications systems 400. For example, the process flow 500 may include a network entity 105-g, a network entity 105-h, a network entity 105-j, and a UE 115-e. The UE 115-e may represent an example of a UE 115 as described herein, including with reference to FIG. 1. The network entity 105-g, the network entity 105-h, and the network entity 105-j may represent examples of network entities 105 as described herein, including with reference to FIG. 1. In some case, the UE 115-e may receive, from the network entity 105-g, a random first random access response and may determine a random access procedure associated with the random access response based on an indication in the first random access response.

In some cases, at 505, a network entity 105-g (e.g., a network entity 105 not in communication with a UE 115-e) may receive a first control message from a network entity 105-h (e.g., a network entity 105 in communication with the UE 115-e) indicating a first random access (e.g., RACH) procedure for the UE 115-e. In some cases, the first control message may include an indication of a timing advance group or a random access preamble identifier associated with the first random access procedure.

In some cases, at 510, the network entity 105-g may receive a first control message from a network entity 105-j (e.g., a network entity 105 in communication with the UE 115-e) indicating a second random access procedure for the UE 115-e, the second random access procedure being during the first random access procedure. In some cases, the second control message may include an indication of a timing advance group or a preamble identifier (e.g., random access preamble identifier) associated with the second RACH procedure.

In some cases, at 515, the UE 115-e may receive a third control message (e.g., RRC message) indicating that a component carrier (e.g., or TRP) is associated with both a first timing advance group and a second timing advance group.

In some cases, at 520, the UE 115-e may receive, from the network entity 105-h) a first PDCCH order (e.g., a fourth control message in the first PDCCH order) triggering the first random access procedure. The first PDCCH order may also indicate (e.g., allocate) a first preamble identifier associated with the first random access procedure. In some cases, the first PDCCH order may be associated with a first CORESET pool index.

In some cases, at 525, the UE 115-e may receive, from the network entity 105-j (e.g., a different network entity 105 than the network entity 105-h), a second PDCCH order (e.g., a fifth control message in the second PDCCH order) triggering the second random access procedure. The second PDCCH order may also indicate (e.g., allocate) a second preamble identifier associated with the second random access procedure. In some cases, the second PDCCH order may be associated with a second CORESET pool index.

At 530, the UE 115-e may transmit a first random access preamble corresponding to the first preamble identifier and monitor for a RAR associated with the first random access preamble. In some cases, the UE 115-e may transmit the first random access preamble via a first random access (e.g., RACH) occasion.

At 535, the UE 115-e may transmit a second random access preamble corresponding to the second preamble identifier and monitor for a RAR associated with the second random access preamble. In some cases, the UE 115-e may transmit the second random access preamble via a second random access occasion.

At 540, the UE 115-e may receive a first RAR associated with the first random access procedure or the second random access procedure based at least in part on an indication included in the first random access response. In some cases, the first RAR may include a PDSCH and the UE 115-e may receive the PDSCH associated with the first RAR or second RAR based on the preamble identifier indication. Additionally, the UE 115-e may receive a PDCCH scrambled by a random access temporary identifier, where the first RAR includes the PDCCH scrambled by the random access temporary identifier.

In some cases, the indication may be a preamble identifier indication (e.g., a RAPID). In some cases, the first RAR may be associated with the first random access procedure based on the preamble identifier indication corresponding to the first preamble identifier. In some other cases, the first RAR may be associated with the second random access procedure based on the preamble identifier indication corresponding to the second preamble identifier.

In some cases, the indication may be an indication of a timing advance group. In some cases, the UE 115-e may receive a timing advance group identifier in a field of the RAR, where the indication of the timing advance group is based on the timing advance group identifier.

In some cases, the UE 115-e may receive the indication of the timing advance group in one or more fields of the RAR, where the one or more fields includes a reserved field and a CSI request field. In some cases, the indication of the timing advance group is based on the random access temporary identifier. For example, the UE 115-e may receive an indication of a third CORESET pool index in the PDCCH scrambled by the random access temporary identifier, where the third CORESET pool index is associated with either the first random access procedure or the second random access procedure. In some cases, the third CORESET pool index is based on the random access temporary identifier. In another example, the UE 115-e may receive an indication of a timing advance group identifier in the PDCCH scrambled by the random access temporary identifier, where the timing advance group identifier is based on the random access temporary identifier and associated with either the first random access procedure or the second random access procedure. In some cases, the UE 115-e may receive the indication of the timing advance group in one or more reserved bits in the PDCCH scrambled by the random access temporary identifier.

In some cases, at 545, the UE 115-e may determine the first random access procedure is associated with the timing advance group based on the first PDCCH order being associated with the first CORESET pool index and the first CORESET pool index being associated with the timing advance group, or the first random access occasion being associated with the timing advance group. In some other cases, the UE 115-e may determine the second random access procedure is associated with the timing advance group based on the second PDCCH order being associated with the second CORESET pool index and the second CORESET pool index being associated with the timing advance group, or the second random access occasion being associated with the timing advance group.

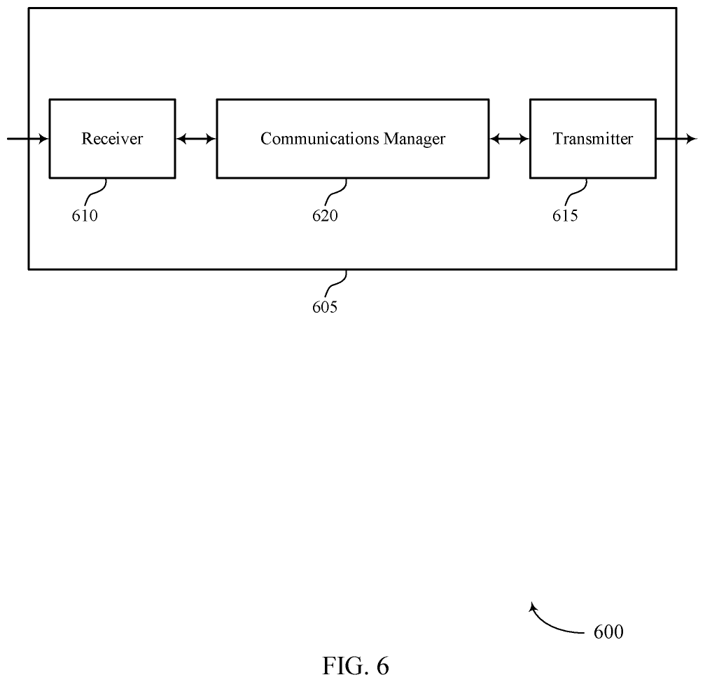

FIG. 6 shows a block diagram 600 of a device 605 that supports RAR enhancements for multiple RACH procedures in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to RAR enhancements for multiple RACH procedures). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RAR enhancements for multiple RACH procedures). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of RAR enhancements for multiple RACH procedures as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving a first control message in a first PDCCH order triggering a first random access procedure, the first control message indicating a first preamble identifier associated with the first random access procedure. The communications manager 620 may be configured as or otherwise support a means for receiving a second control message in a second PDCCH order triggering a second random access procedure during the first random access procedure, the second control message indicating a second preamble identifier associated with the second random access procedure, where the first preamble identifier is different than the second preamble identifier. The communications manager 620 may be configured as or otherwise support a means for transmitting a first random access preamble corresponding to the first preamble identifier and a second random access preamble corresponding to the second preamble identifier. The communications manager 620 may be configured as or otherwise support a means for receiving a random access response associated with one of the first random access procedure or the second random access procedure based on a preamble identifier indication included in the random access response.

Additionally, or alternatively, the communications manager 620 may support wireless communications at a UE in accordance with examples as disclosed herein. For example, the communications manager 620 may be configured as or otherwise support a means for transmitting a first random access preamble corresponding to a first preamble identifier as part of a first random access procedure. The communications manager 620 may be configured as or otherwise support a means for transmitting, during the first random access procedure, a second random access preamble corresponding to a second preamble identifier, the second random access preamble associated with a second random access procedure. The communications manager 620 may be configured as or otherwise support a means for receiving a random access response associated with one of the first random access procedure or the second random access procedure based on an indication of a timing advance group in the random access response.

Additionally, or alternatively, the communications manager 620 may support wireless communications at a UE in accordance with examples as disclosed herein. For example, the communications manager 620 may be configured as or otherwise support a means for receiving an RRC message indicating that a component carrier is associated with both a first timing advance group and a second timing advance group. The communications manager 620 may be configured as or otherwise support a means for receiving, via a first PDCCH order, a first control message triggering a first random access procedure, where the first PDCCH order is associated with a first CORESET pool index. The communications manager 620 may be configured as or otherwise support a means for receiving, via a second PDCCH order and during the first random access procedure, a second control message triggering a second random access procedure, where the second PDCCH order is associated with a second CORESET pool index. The communications manager 620 may be configured as or otherwise support a means for transmitting a first random access preamble via a first random access occasion on the component carrier and a second random access preamble via a second random access occasion on the component carrier. The communications manager 620 may be configured as or otherwise support a means for receiving a random access response that includes an indication of a timing advance group, where the random access response is associated with the first random access procedure based on the timing advance group corresponding to the first CORESET pool index or the first random access occasion, or the random access response is associated with the second random access procedure based on the timing advance group corresponding to the second CORESET pool index or the second random access occasion.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for RAR enhancements for multiple RACH procedures which may result in reduced processing, reduced power consumption, and more efficient utilization of communication resources, among other advantages.

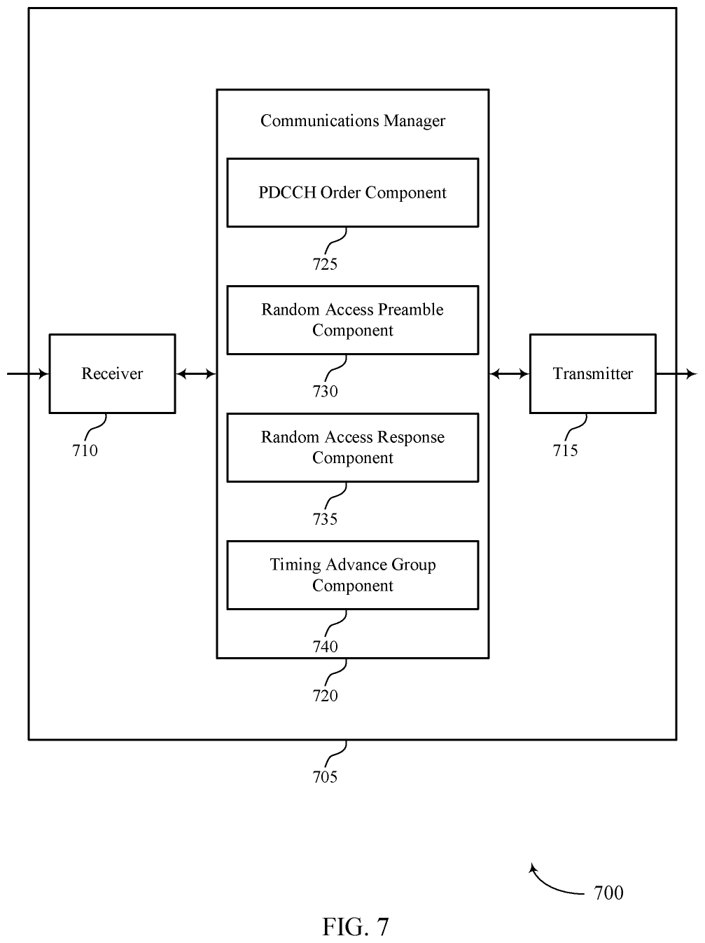

FIG. 7 shows a block diagram 700 of a device 705 that supports RAR enhancements for multiple RACH procedures in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to RAR enhancements for multiple RACH procedures). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RAR enhancements for multiple RACH procedures). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of RAR enhancements for multiple RACH procedures as described herein. For example, the communications manager 720 may include a PDCCH order component 725, a random access preamble component 730, a random access response component 735, a timing advance group component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The PDCCH order component 725 may be configured as or otherwise support a means for receiving a first control message in a first PDCCH order triggering a first random access procedure, the first control message indicating a first preamble identifier associated with the first random access procedure. The PDCCH order component 725 may be configured as or otherwise support a means for receiving a second control message in a second PDCCH order triggering a second random access procedure during the first random access procedure, the second control message indicating a second preamble identifier associated with the second random access procedure, where the first preamble identifier is different than the second preamble identifier. The random access preamble component 730 may be configured as or otherwise support a means for transmitting a first random access preamble corresponding to the first preamble identifier and a second random access preamble corresponding to the second preamble identifier. The random access response component 735 may be configured as or otherwise support a means for receiving a random access response associated with one of the first random access procedure or the second random access procedure based on a preamble identifier indication included in the random access response.

Additionally, or alternatively, the communications manager 720 may support wireless communications at a UE in accordance with examples as disclosed herein. The random access preamble component 730 may be configured as or otherwise support a means for transmitting a first random access preamble corresponding to a first preamble identifier as part of a first random access procedure. The random access preamble component 730 may be configured as or otherwise support a means for transmitting, during the first random access procedure, a second random access preamble corresponding to a second preamble identifier, the second random access preamble associated with a second random access procedure. The random access response component 735 may be configured as or otherwise support a means for receiving a random access response associated with one of the first random access procedure or the second random access procedure based on an indication of a timing advance group in the random access response.

Additionally, or alternatively, the communications manager 720 may support wireless communications at a UE in accordance with examples as disclosed herein. The timing advance group component 740 may be configured as or otherwise support a means for receiving an RRC message indicating that a component carrier is associated with both a first timing advance group and a second timing advance group. The PDCCH order component 725 may be configured as or otherwise support a means for receiving, via a first PDCCH order, a first control message triggering a first random access procedure, where the first PDCCH order is associated with a first CORESET pool index. The PDCCH order component 725 may be configured as or otherwise support a means for receiving, via a second PDCCH order and during the first random access procedure, a second control message triggering a second random access procedure, where the second PDCCH order is associated with a second CORESET pool index. The random access preamble component 730 may be configured as or otherwise support a means for transmitting a first random access preamble via a first random access occasion on the component carrier and a second random access preamble via a second random access occasion on the component carrier. The random access response component 735 may be configured as or otherwise support a means for receiving a random access response that includes an indication of a timing advance group, where the random access response is associated with the first random access procedure based on the timing advance group corresponding to the first CORESET pool index or the first random access occasion, or the random access response is associated with the second random access procedure based on the timing advance group corresponding to the second CORESET pool index or the second random access occasion.

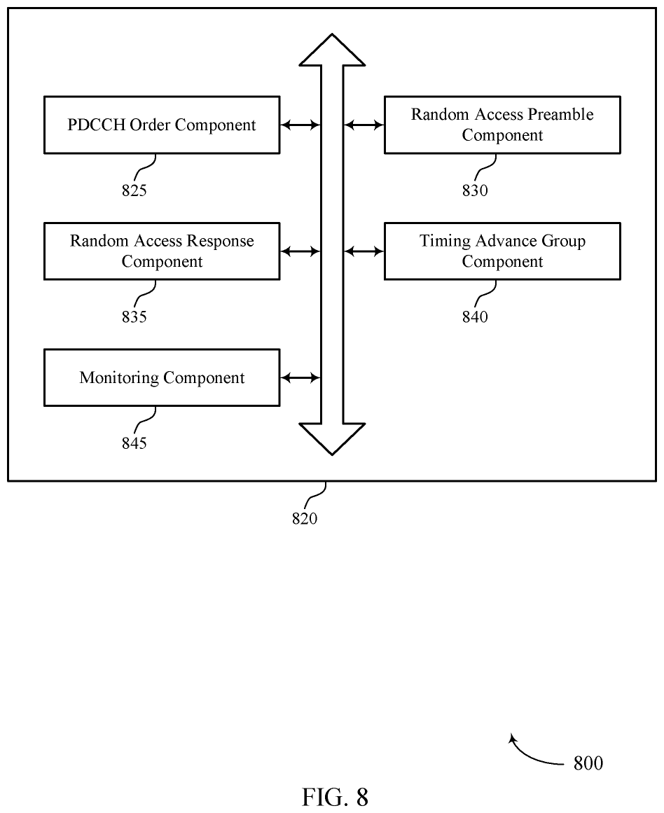

FIG. 8 shows a block diagram 800 of a communications manager 820 that supports RAR enhancements for multiple RACH procedures in accordance with one or more aspects of the present disclosure. The communications manager 820 may be an example of aspects of a communications manager 620, a communications manager 720, or both, as described herein. The communications manager 820, or various components thereof, may be an example of means for performing various aspects of RAR enhancements for multiple RACH procedures as described herein. For example, the communications manager 820 may include a PDCCH order component 825, a random access preamble component 830, a random access response component 835, a timing advance group component 840, a monitoring component 845, or any combination thereof. Each of these components may communicate, directly or indirectly, with one another (e.g., via one or more buses).

The communications manager 820 may support wireless communications at a UE in accordance with examples as disclosed herein. The PDCCH order component 825 may be configured as or otherwise support a means for receiving a first control message in a first PDCCH order triggering a first random access procedure, the first control message indicating a first preamble identifier associated with the first random access procedure. In some examples, the PDCCH order component 825 may be configured as or otherwise support a means for receiving a second control message in a second PDCCH order triggering a second random access procedure during the first random access procedure, the second control message indicating a second preamble identifier associated with the second random access procedure, where the first preamble identifier is different than the second preamble identifier. The random access preamble component 830 may be configured as or otherwise support a means for transmitting a first random access preamble corresponding to the first preamble identifier and a second random access preamble corresponding to the second preamble identifier. The random access response component 835 may be configured as or otherwise support a means for receiving a random access response associated with one of the first random access procedure or the second random access procedure based on a preamble identifier indication included in the random access response.

In some examples, the monitoring component 845 may be configured as or otherwise support a means for monitoring for the random access response associated the first random access procedure. In some examples, the monitoring component 845 may be configured as or otherwise support a means for monitoring for the random access response associated with the second random access procedure.

In some examples, to support receiving the random access response, the random access response component 835 may be configured as or otherwise support a means for receiving the random access response associated with the first random access procedure based on the preamble identifier indication corresponding to the first preamble identifier. In some examples, to support receiving the random access response, the random access response component 835 may be configured as or otherwise support a means for receiving the random access response associated with the second random access procedure based on the preamble identifier indication corresponding to the second preamble identifier.

In some examples, the random access response component 835 may be configured as or otherwise support a means for receiving a PDSCH associated with the first random access procedure or the second random access procedure based on the preamble identifier indication included in the random access response, where the random access response includes the PDSCH.

In some examples, to support receiving the first control message and the second control message, the PDCCH order component 825 may be configured as or otherwise support a means for receiving the first PDCCH order from a first network entity. In some examples, to support receiving the first control message and the second control message, the PDCCH order component 825 may be configured as or otherwise support a means for receiving the second PDCCH order from a second network entity different from the first network entity.

Additionally, or alternatively, the communications manager 820 may support wireless communications at a UE in accordance with examples as disclosed herein. In some examples, the random access preamble component 830 may be configured as or otherwise support a means for transmitting a first random access preamble corresponding to a first preamble identifier as part of a first random access procedure. In some examples, the random access preamble component 830 may be configured as or otherwise support a means for transmitting, during the first random access procedure, a second random access preamble corresponding to a second preamble identifier, the second random access preamble associated with a second random access procedure. In some examples, the random access response component 835 may be configured as or otherwise support a means for receiving a random access response associated with one of the first random access procedure or the second random access procedure based on an indication of a timing advance group in the random access response.

In some examples, the monitoring component 845 may be configured as or otherwise support a means for monitoring for the random access response associated with the first random access procedure. In some examples, the monitoring component 845 may be configured as or otherwise support a means for monitoring for the random access response associated with the second random access procedure.

In some examples, the PDCCH order component 825 may be configured as or otherwise support a means for receiving a first control message in a first PDCCH order associated with the first random access procedure, the first control message indicating the first preamble identifier. In some examples, the PDCCH order component 825 may be configured as or otherwise support a means for receiving a second control message in a second PDCCH order associated with the second random access procedure, the second control message indicating the second preamble identifier.

In some examples, to support receiving the first control message and the second control message, the PDCCH order component 825 may be configured as or otherwise support a means for receiving the first control message in the first PDCCH order from a first network entity. In some examples, to support receiving the first control message and the second control message, the PDCCH order component 825 may be configured as or otherwise support a means for receiving the second control message in the second PDCCH order from a second network entity different from the first network entity.

In some examples, the random access response component 835 may be configured as or otherwise support a means for receiving a PDSCH associated with the first random access procedure or the second random access procedure based on the indication of the timing advance group included in the random access response, where the random access response includes the PDSCH.

In some examples, to support receiving the random access response, the timing advance group component 840 may be configured as or otherwise support a means for receiving a timing advance group identifier in a field of the random access response, where the indication of the timing advance group is based on the timing advance group identifier.

In some examples, to support receiving the random access response, the timing advance group component 840 may be configured as or otherwise support a means for receiving the indication of the timing advance group in one or more fields of the random access response, where the one or more fields includes a reserved field and a CSI request field.

In some examples, to support receiving the random access response, the timing advance group component 840 may be configured as or otherwise support a means for receiving a PDCCH scrambled by a random access temporary identifier, where the indication of the timing advance group is based on the random access temporary identifier and where the random access response includes the PDCCH scrambled by the random access temporary identifier.

In some examples, to support receiving the PDCCH scrambled by the random access temporary identifier, the timing advance group component 840 may be configured as or otherwise support a means for receiving an indication of a CORESET pool index in the PDCCH scrambled by the random access temporary identifier, where the CORESET pool index is based on the random access temporary identifier and is associated with the first random access procedure or the second random access procedure.

In some examples, to support receiving the PDCCH scrambled by the random access temporary identifier, the timing advance group component 840 may be configured as or otherwise support a means for receiving an indication of a timing advance group identifier in the PDCCH scrambled by the random access temporary identifier, where the timing advance group identifier is based on the random access temporary identifier and is associated with the first random access procedure or the second random access procedure.

In some examples, to support receiving the random access response, the timing advance group component 840 may be configured as or otherwise support a means for receiving the indication of the timing advance group in one or more reserved bits in a PDCCH scrambled by a random access temporary identifier, where the random access response includes the PDCCH.

In some examples, to support receiving the random access response, the timing advance group component 840 may be configured as or otherwise support a means for receiving an indication of a CORESET pool index in one or more reserved bits in a PDCCH scrambled by a random access temporary identifier, where the CORESET pool index is associated with the timing advance group and where the random access response includes the PDCCH.

Additionally, or alternatively, the communications manager 820 may support wireless communications at a UE in accordance with examples as disclosed herein. The timing advance group component 840 may be configured as or otherwise support a means for receiving an RRC message indicating that a component carrier is associated with both a first timing advance group and a second timing advance group. In some examples, the PDCCH order component 825 may be configured as or otherwise support a means for receiving, via a first PDCCH order, a first control message triggering a first random access procedure, where the first PDCCH order is associated with a first CORESET pool index. In some examples, the PDCCH order component 825 may be configured as or otherwise support a means for receiving, via a second PDCCH order and during the first random access procedure, a second control message triggering a second random access procedure, where the second PDCCH order is associated with a second CORESET pool index. In some examples, the random access preamble component 830 may be configured as or otherwise support a means for transmitting a first random access preamble via a first random access occasion on the component carrier and a second random access preamble via a second random access occasion on the component carrier. In some examples, the random access response component 835 may be configured as or otherwise support a means for receiving a random access response that includes an indication of a timing advance group, where the random access response is associated with the first random access procedure based on the timing advance group corresponding to the first CORESET pool index or the first random access occasion, or the random access response is associated with the second random access procedure based on the timing advance group corresponding to the second CORESET pool index or the second random access occasion.

In some examples, the timing advance group component 840 may be configured as or otherwise support a means for determining the first random access procedure is associated with the timing advance group based on the first PDCCH order being associated with the first CORESET pool index and the first CORESET pool index being associated with the timing advance group, or the first random access occasion being associated with the timing advance group. In some examples, the timing advance group component 840 may be configured as or otherwise support a means for determining, the second random access procedure is associated with the timing advance group based on the second PDCCH order being associated with the second CORESET pool index and the second CORESET pool index being associated with the timing advance group, or the second random access occasion being associated with the timing advance group.

In some examples, the random access response component 835 may be configured as or otherwise support a means for monitoring for the random access response associated with the first random access procedure. In some examples, the random access response component 835 may be configured as or otherwise support a means for monitoring for the random access response associated with the second random access procedure.

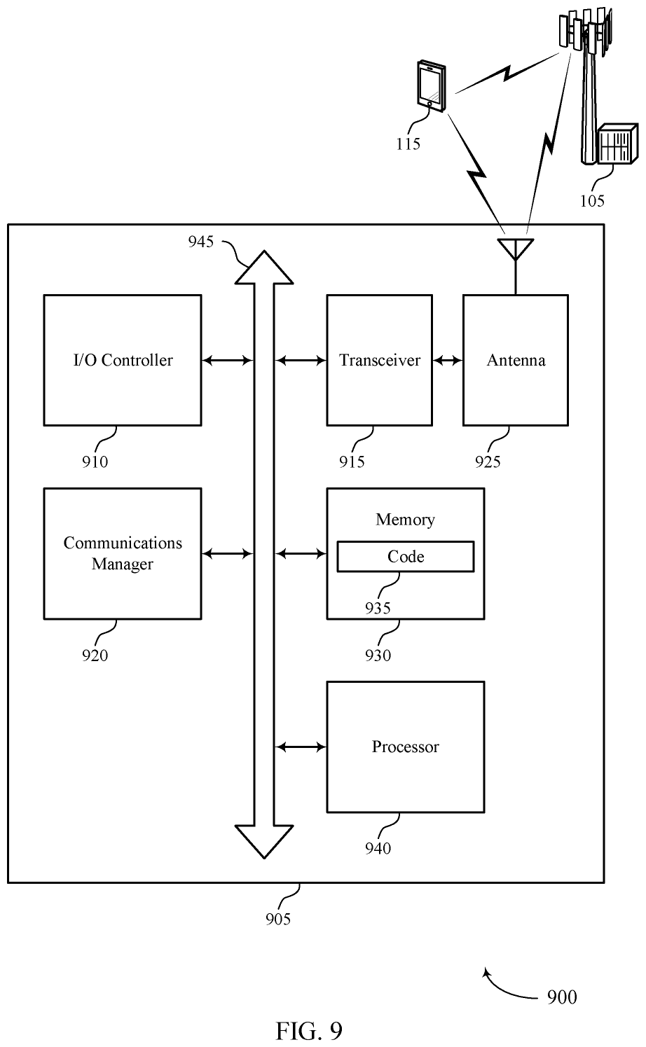

FIG. 9 shows a diagram of a system 900 including a device 905 that supports RAR enhancements for multiple RACH procedures in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting RAR enhancements for multiple RACH procedures). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving a first control message in a first PDCCH order triggering a first random access procedure, the first control message indicating a first preamble identifier associated with the first random access procedure. The communications manager 920 may be configured as or otherwise support a means for receiving a second control message in a second PDCCH order triggering a second random access procedure during the first random access procedure, the second control message indicating a second preamble identifier associated with the second random access procedure, where the first preamble identifier is different than the second preamble identifier. The communications manager 920 may be configured as or otherwise support a means for transmitting a first random access preamble corresponding to the first preamble identifier and a second random access preamble corresponding to the second preamble identifier. The communications manager 920 may be configured as or otherwise support a means for receiving a random access response associated with one of the first random access procedure or the second random access procedure based on a preamble identifier indication included in the random access response.

Additionally, or alternatively, the communications manager 920 may support wireless communications at a UE in accordance with examples as disclosed herein. For example, the communications manager 920 may be configured as or otherwise support a means for transmitting a first random access preamble corresponding to a first preamble identifier as part of a first random access procedure. The communications manager 920 may be configured as or otherwise support a means for transmitting, during the first random access procedure, a second random access preamble corresponding to a second preamble identifier, the second random access preamble associated with a second random access procedure. The communications manager 920 may be configured as or otherwise support a means for receiving a random access response associated with one of the first random access procedure or the second random access procedure based on an indication of a timing advance group in the random access response.

Additionally, or alternatively, the communications manager 920 may support wireless communications at a UE in accordance with examples as disclosed herein. For example, the communications manager 920 may be configured as or otherwise support a means for receiving an RRC message indicating that a component carrier is associated with both a first timing advance group and a second timing advance group. The communications manager 920 may be configured as or otherwise support a means for receiving, via a first PDCCH order, a first control message triggering a first random access procedure, where the first PDCCH order is associated with a first CORESET pool index. The communications manager 920 may be configured as or otherwise support a means for receiving, via a second PDCCH order and during the first random access procedure, a second control message triggering a second random access procedure, where the second PDCCH order is associated with a second CORESET pool index. The communications manager 920 may be configured as or otherwise support a means for transmitting a first random access preamble via a first random access occasion on the component carrier and a second random access preamble via a second random access occasion on the component carrier. The communications manager 920 may be configured as or otherwise support a means for receiving a random access response that includes an indication of a timing advance group, where the random access response is associated with the first random access procedure based on the timing advance group corresponding to the first CORESET pool index or the first random access occasion, or the random access response is associated with the second random access procedure based on the timing advance group corresponding to the second CORESET pool index or the second random access occasion.

By including or configuring the communications manager 920 in accordance with examples as described herein, the device 905 may support techniques for RAR enhancements for multiple RACH procedures which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of RAR enhancements for multiple RACH procedures as described herein, or the processor 940 and the memory 930 may be otherwise configured to perform or support such operations.

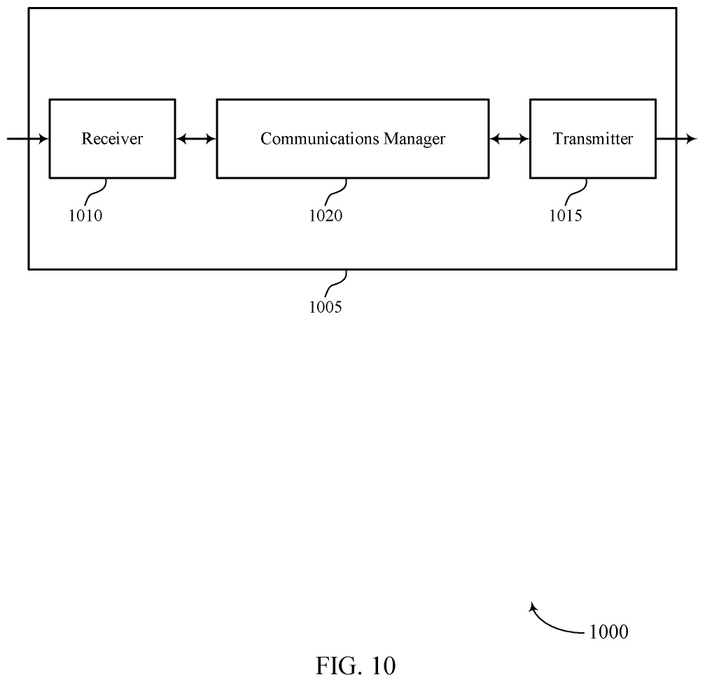

FIG. 10 shows a block diagram 1000 of a device 1005 that supports RAR enhancements for multiple RACH procedures in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of RAR enhancements for multiple RACH procedures as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for receiving a first control message indicating a first random access procedure for a UE. The communications manager 1020 may be configured as or otherwise support a means for receiving a second control message indicating a second random access procedure during the first random access procedure, the second random access procedure for the UE. The communications manager 1020 may be configured as or otherwise support a means for transmitting, to the UE, a random access response associated with one of the first random access procedure or the second random access procedure, the random access response including an indication of one of the first random access procedure or the second random access procedure.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for RAR enhancements for multiple RACH procedures which may result in reduced processing, reduced power consumption, and more efficient utilization of communication resources, among other advantages.

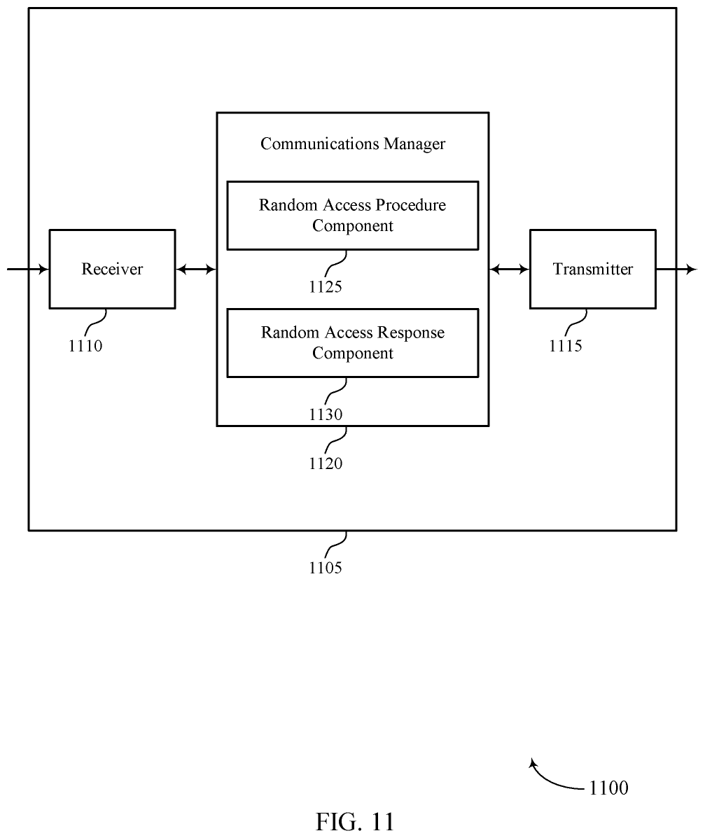

FIG. 11 shows a block diagram 1100 of a device 1105 that supports RAR enhancements for multiple RACH procedures in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of RAR enhancements for multiple RACH procedures as described herein. For example, the communications manager 1120 may include a random access procedure component 1125 a random access response component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The random access procedure component 1125 may be configured as or otherwise support a means for receiving a first control message indicating a first random access procedure for a UE. The random access procedure component 1125 may be configured as or otherwise support a means for receiving a second control message indicating a second random access procedure during the first random access procedure, the second random access procedure for the UE. The random access response component 1130 may be configured as or otherwise support a means for transmitting, to the UE, a random access response associated with one of the first random access procedure or the second random access procedure, the random access response including an indication of one of the first random access procedure or the second random access procedure.

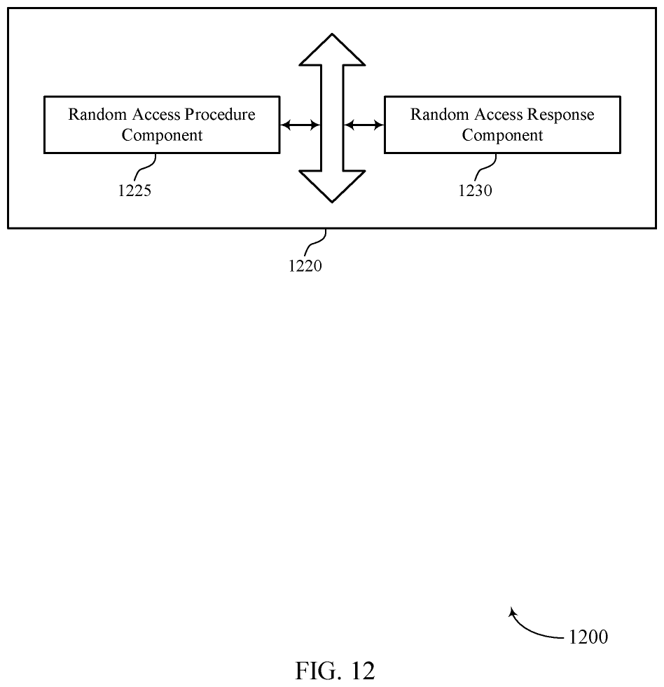

FIG. 12 shows a block diagram 1200 of a communications manager 1220 that supports RAR enhancements for multiple RACH procedures in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of RAR enhancements for multiple RACH procedures as described herein. For example, the communications manager 1220 may include a random access procedure component 1225 a random access response component 1230, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The random access procedure component 1225 may be configured as or otherwise support a means for receiving a first control message indicating a first random access procedure for a UE. In some examples, the random access procedure component 1225 may be configured as or otherwise support a means for receiving a second control message indicating a second random access procedure during the first random access procedure, the second random access procedure for the UE. The random access response component 1230 may be configured as or otherwise support a means for transmitting, to the UE, a random access response associated with one of the first random access procedure or the second random access procedure, the random access response including an indication of one of the first random access procedure or the second random access procedure.

In some examples, to support transmitting the random access response, the random access response component 1230 may be configured as or otherwise support a means for transmitting a preamble identifier associated with the first random access procedure or the second random access procedure, where the indication included in the random access response is based on the preamble identifier.

In some examples, to support transmitting the random access response, the random access response component 1230 may be configured as or otherwise support a means for transmitting an indication of a timing advance group associated with the first random access procedure or the second random access procedure, where the indication included in the random access response is the indication of the timing advance group.

In some examples, to support transmitting the indication of the timing advance group, the random access response component 1230 may be configured as or otherwise support a means for transmitting a timing advance group identifier in a field of the random access response, where the indication of the timing advance group is based on the timing advance group identifier.

In some examples, to support transmitting the indication of the timing advance group, the random access response component 1230 may be configured as or otherwise support a means for transmitting the indication of the timing advance group in one or more fields of the random access response, where the one or more fields includes a reserved field, a CSI request field, or both.

In some examples, to support transmitting the indication of the timing advance group, the random access response component 1230 may be configured as or otherwise support a means for transmitting a PDCCH scrambled by a random access temporary identifier, where the indication of the timing advance group is based on the random access temporary identifier and where the random access response includes the PDCCH scrambled by the random access temporary identifier.

In some examples, to support transmitting the PDCCH scrambled by the random access temporary identifier, the random access response component 1230 may be configured as or otherwise support a means for transmitting an indication of a CORESET pool index in the PDCCH scrambled by the random access temporary identifier, where the CORESET pool index is based on the random access temporary identifier and is associated with the first random access procedure or the second random access procedure.

In some examples, to support transmitting the PDCCH scrambled by the random access temporary identifier, the random access response component 1230 may be configured as or otherwise support a means for transmitting an indication of a timing advance group identifier in the PDCCH scrambled by the random access temporary identifier, where the timing advance group identifier is based on the random access temporary identifier and is associated with the first random access procedure or the second random access procedure.

In some examples, to support transmitting the indication of the timing advance group, the random access response component 1230 may be configured as or otherwise support a means for transmitting the indication of the timing advance group in one or more reserved bits in a PDCCH scrambled by a random access temporary identifier, where the random access response includes the PDCCH.

In some examples, to support transmitting the random access response, the random access response component 1230 may be configured as or otherwise support a means for transmitting an indication of a CORESET pool index in one or more bits in a PDCCH scrambled by a random access temporary identifier, where the random access response includes the PDCCH.

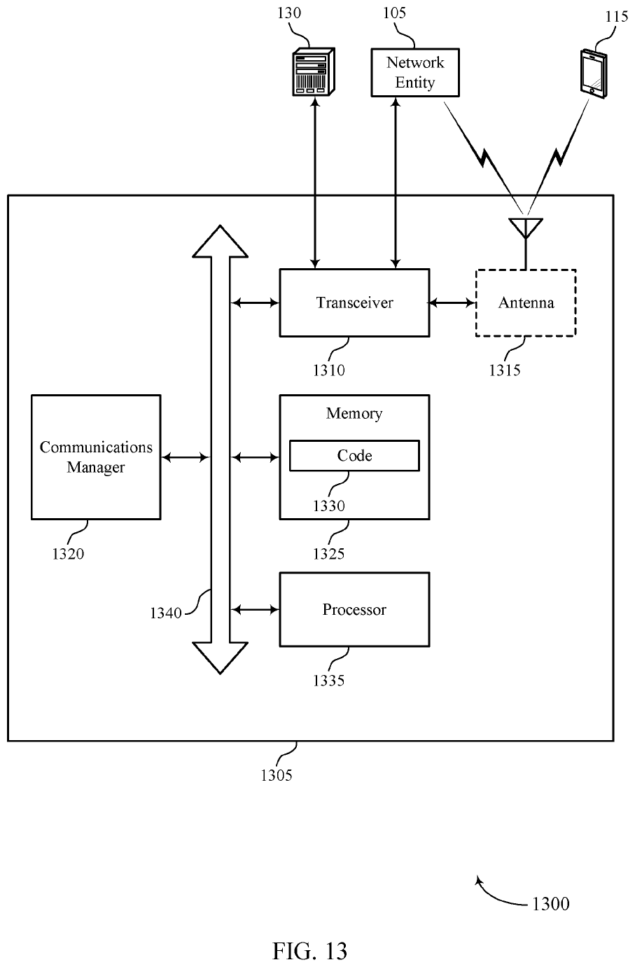

FIG. 13 shows a diagram of a system 1300 including a device 1305 that supports RAR enhancements for multiple RACH procedures in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting RAR enhancements for multiple RACH procedures). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for receiving a first control message indicating a first random access procedure for a UE. The communications manager 1320 may be configured as or otherwise support a means for receiving a second control message indicating a second random access procedure during the first random access procedure, the second random access procedure for the UE. The communications manager 1320 may be configured as or otherwise support a means for transmitting, to the UE, a random access response associated with one of the first random access procedure or the second random access procedure, the random access response including an indication of one of the first random access procedure or the second random access procedure.

By including or configuring the communications manager 1320 in accordance with examples as described herein, the device 1305 may support techniques for RAR enhancements for multiple RACH procedures which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of RAR enhancements for multiple RACH procedures as described herein, or the processor 1335 and the memory 1325 may be otherwise configured to perform or support such operations.

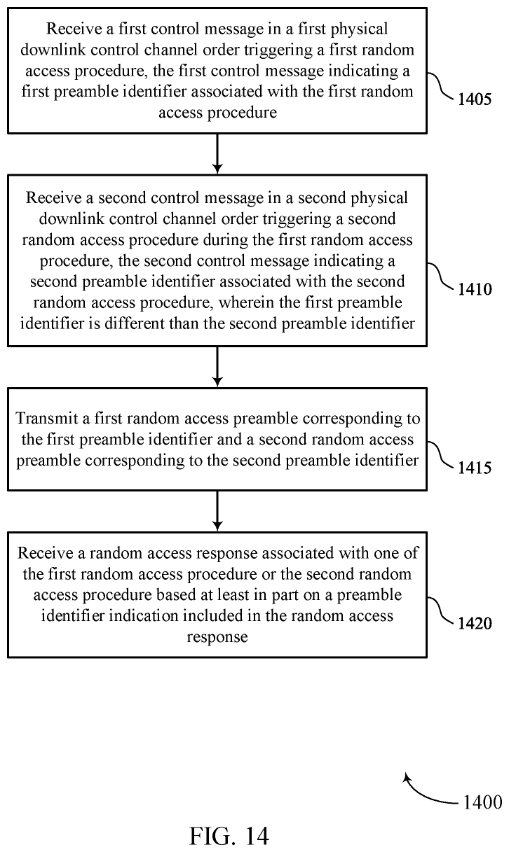

FIG. 14 shows a flowchart illustrating a method 1400 that supports RAR enhancements for multiple RACH procedures in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a first control message in a first PDCCH order triggering a first random access procedure, the first control message indicating a first preamble identifier associated with the first random access procedure. The operations of 1405 may be performed in accordance with examples as disclosed herein. In some examples, aspects of the operations of 1405 may be performed by a PDCCH order component 825 as described with reference to FIG. 8.

At 1410, the method may include receiving a second control message in a second PDCCH order triggering a second random access procedure during the first random access procedure, the second control message indicating a second preamble identifier associated with the second random access procedure, where the first preamble identifier is different than the second preamble identifier. The operations of 1410 may be performed in accordance with examples as disclosed herein. In some examples, aspects of the operations of 1410 may be performed by a PDCCH order component 825 as described with reference to FIG. 8.

At 1415, the method may include transmitting a first random access preamble corresponding to the first preamble identifier and a second random access preamble corresponding to the second preamble identifier. The operations of 1415 may be performed in accordance with examples as disclosed herein. In some examples, aspects of the operations of 1415 may be performed by a random access preamble component 830 as described with reference to FIG. 8.

At 1420, the method may include receiving a random access response associated with one of the first random access procedure or the second random access procedure based on a preamble identifier indication included in the random access response. The operations of 1420 may be performed in accordance with examples as disclosed herein. In some examples, aspects of the operations of 1420 may be performed by a random access response component 835 as described with reference to FIG. 8.

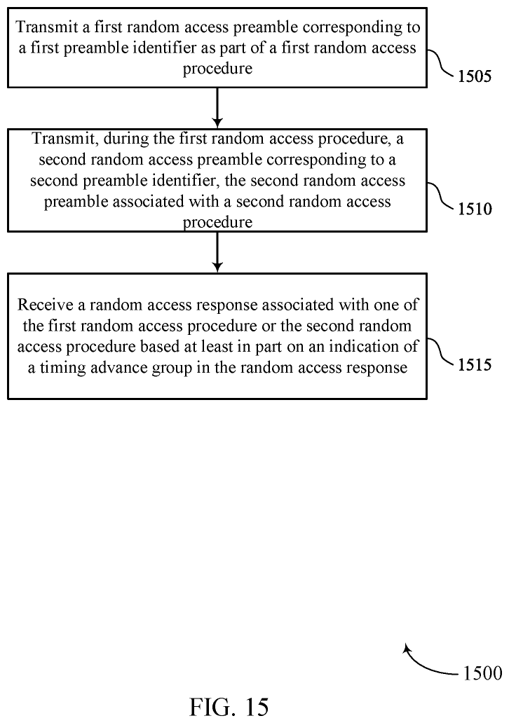

FIG. 15 shows a flowchart illustrating a method 1500 that supports RAR enhancements for multiple RACH procedures in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a first random access preamble corresponding to a first preamble identifier as part of a first random access procedure. The operations of 1505 may be performed in accordance with examples as disclosed herein. In some examples, aspects of the operations of 1505 may be performed by a random access preamble component 830 as described with reference to FIG. 8.

At 1510, the method may include transmitting, during the first random access procedure, a second random access preamble corresponding to a second preamble identifier, the second random access preamble associated with a second random access procedure. The operations of 1510 may be performed in accordance with examples as disclosed herein. In some examples, aspects of the operations of 1510 may be performed by a random access preamble component 830 as described with reference to FIG. 8.

At 1515, the method may include receiving a random access response associated with one of the first random access procedure or the second random access procedure based on an indication of a timing advance group in the random access response. The operations of 1515 may be performed in accordance with examples as disclosed herein. In some examples, aspects of the operations of 1515 may be performed by a random access response component 835 as described with reference to FIG. 8.

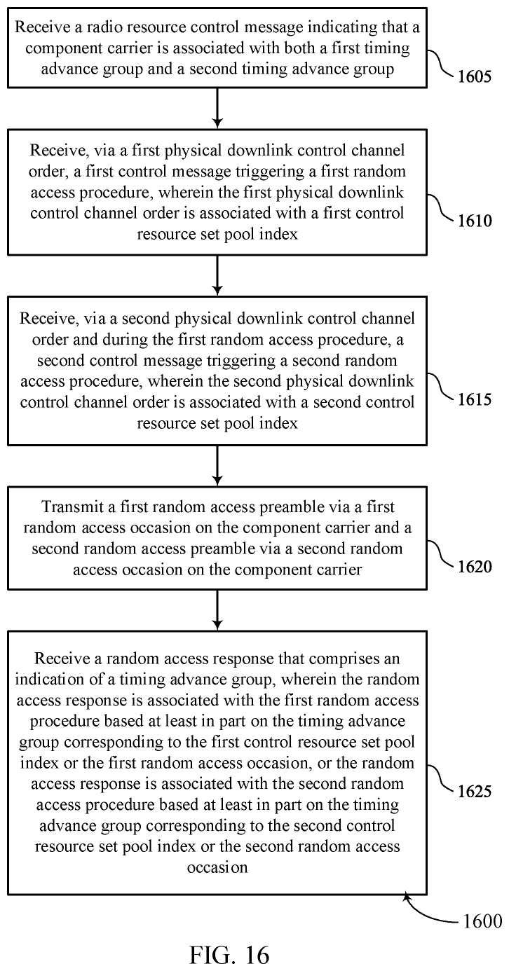

FIG. 16 shows a flowchart illustrating a method 1600 that supports RAR enhancements for multiple RACH procedures in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving an RRC message indicating that a component carrier is associated with both a first timing advance group and a second timing advance group. The operations of 1605 may be performed in accordance with examples as disclosed herein. In some examples, aspects of the operations of 1605 may be performed by a timing advance group component 840 as described with reference to FIG. 8.

At 1610, the method may include receiving, via a first PDCCH order, a first control message triggering a first random access procedure, where the first PDCCH order is associated with a first CORESET pool index. The operations of 1610 may be performed in accordance with examples as disclosed herein. In some examples, aspects of the operations of 1610 may be performed by a PDCCH order component 825 as described with reference to FIG. 8.

At 1615, the method may include receiving, via a second PDCCH order and during the first random access procedure, a second control message triggering a second random access procedure, where the second PDCCH order is associated with a second CORESET pool index. The operations of 1615 may be performed in accordance with examples as disclosed herein. In some examples, aspects of the operations of 1615 may be performed by a PDCCH order component 825 as described with reference to FIG. 8.

At 1620, the method may include transmitting a first random access preamble via a first random access occasion on the component carrier and a second random access preamble via a second random access occasion on the component carrier. The operations of 1620 may be performed in accordance with examples as disclosed herein. In some examples, aspects of the operations of 1620 may be performed by a random access preamble component 830 as described with reference to FIG. 8.

At 1625, the method may include receiving a random access response that includes an indication of a timing advance group, where the random access response is associated with the first random access procedure based on the timing advance group corresponding to the first CORESET pool index or the first random access occasion, or the random access response is associated with the second random access procedure based on the timing advance group corresponding to the second CORESET pool index or the second random access occasion. The operations of 1625 may be performed in accordance with examples as disclosed herein. In some examples, aspects of the operations of 1625 may be performed by a random access response component 835 as described with reference to FIG. 8.

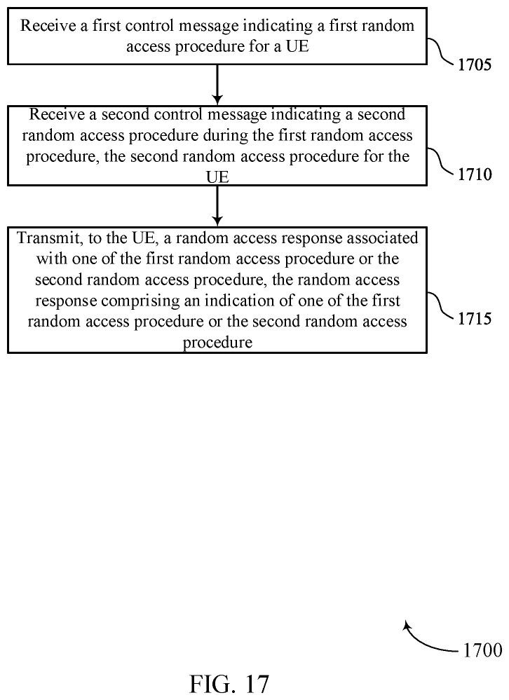

FIG. 17 shows a flowchart illustrating a method 1700 that supports RAR enhancements for multiple RACH procedures in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving (e.g., from a first network entity) a first control message indicating a first random access procedure for a UE. The operations of 1705 may be performed in accordance with examples as disclosed herein. In some examples, aspects of the operations of 1705 may be performed by a random access procedure component 1225 as described with reference to FIG. 12.

At 1710, the method may include receiving (e.g., from a second network entity) a second control message indicating a second random access procedure during the first random access procedure, the second random access procedure for the UE. The operations of 1710 may be performed in accordance with examples as disclosed herein. In some examples, aspects of the operations of 1710 may be performed by a random access procedure component 1225 as described with reference to FIG. 12.

At 1715, the method may include transmitting, to the UE, a random access response associated with one of the first random access procedure or the second random access procedure, the random access response including an indication of one of the first random access procedure or the second random access procedure. The operations of 1715 may be performed in accordance with examples as disclosed herein. In some examples, aspects of the operations of 1715 may be performed by a random access response component 1230 as described with reference to FIG. 12.

The following provides an overview of aspects of the present disclosure:

Aspect 1: A method for wireless communications at a UE, comprising: receiving a first control message in a first PDCCH order triggering a first random access procedure, the first control message indicating a first preamble identifier associated with the first random access procedure; receiving a second control message in a second PDCCH order triggering a second random access procedure during the first random access procedure, the second control message indicating a second preamble identifier associated with the second random access procedure, wherein the first preamble identifier is different than the second preamble identifier; transmitting a first random access preamble corresponding to the first preamble identifier and a second random access preamble corresponding to the second preamble identifier; and receiving a RAR associated with one of the first random access procedure or the second random access procedure based at least in part on a preamble identifier indication included in the RAR.

Aspect 2: The method of aspect 1, further comprising: monitoring for the RAR associated the first random access procedure; and monitoring for the RAR associated with the second random access procedure.

Aspect 3: The method of any of aspects 1 through 2, wherein receiving the RAR comprises: receiving the RAR associated with the first random access procedure based at least in part on the preamble identifier indication corresponding to the first preamble identifier; or receiving the RAR associated with the second random access procedure based at least in part on the preamble identifier indication corresponding to the second preamble identifier.

Aspect 4: The method of any of aspects 1 through 3, further comprising: receiving a PDSCH associated with the first random access procedure or the second random access procedure based at least in part on the preamble identifier indication included in the RAR, wherein the RAR comprises the PDSCH.

Aspect 5: The method of any of aspects 1 through 4, wherein receiving the first control message and the second control message comprises: receiving the first PDCCH order from a first network entity; and receiving the second PDCCH order from a second network entity different from the first network entity.

Aspect 6: A method for wireless communications at a UE, comprising: transmitting a first random access preamble corresponding to a first preamble identifier as part of a first random access procedure; transmitting, during the first random access procedure, a second random access preamble corresponding to a second preamble identifier, the second random access preamble associated with a second random access procedure; and receiving a RAR associated with one of the first random access procedure or the second random access procedure based at least in part on an indication of a timing advance group in the RAR.

Aspect 7: The method of aspect 6, further comprising: monitoring for the RAR associated with the first random access procedure; and monitoring for the RAR associated with the second random access procedure.

Aspect 8: The method of any of aspects 6 through 7, further comprising: receiving a first control message in a first PDCCH order associated with the first random access procedure, the first control message indicating the first preamble identifier; and receiving a second control message in a second PDCCH order associated with the second random access procedure, the second control message indicating the second preamble identifier.

Aspect 9: The method of aspect 8, wherein receiving the first control message and the second control message comprises: receiving the first control message in the first PDCCH order from a first network entity; and receiving the second control message in the second PDCCH order from a second network entity different from the first network entity.

Aspect 10: The method of any of aspects 6 through 9, further comprising: receiving a PDSCH associated with the first random access procedure or the second random access procedure based at least in part on the indication of the timing advance group included in the RAR, wherein the RAR comprises the PDSCH.

Aspect 11: The method of any of aspects 6 through 10, wherein receiving the RAR comprises: receiving a timing advance group identifier in a field of the RAR, wherein the indication of the timing advance group is based at least in part on the timing advance group identifier.

Aspect 12: The method of any of aspects 6 through 11, wherein receiving the RAR comprises: receiving the indication of the timing advance group in one or more fields of the RAR, wherein the one or more fields comprises a reserved field and a CSI request field.

Aspect 13: The method of any of aspects 6 through 12, wherein receiving the RAR comprises: receiving a PDCCH scrambled by a random access temporary identifier, wherein the indication of the timing advance group is based at least in part on the random access temporary identifier and wherein the RAR comprises the PDCCH scrambled by the random access temporary identifier.

Aspect 14: The method of aspect 13, wherein receiving the PDCCH scrambled by the random access temporary identifier comprises: receiving an indication of a CORESET pool index in the PDCCH scrambled by the random access temporary identifier, wherein the CORESET pool index is based at least in part on the random access temporary identifier and is associated with the first random access procedure or the second random access procedure.

Aspect 15: The method of any of aspects 13 through 14, wherein receiving the PDCCH scrambled by the random access temporary identifier comprises: receiving an indication of a timing advance group identifier in the PDCCH scrambled by the random access temporary identifier, wherein the timing advance group identifier is based at least in part on the random access temporary identifier and is associated with the first random access procedure or the second random access procedure.

Aspect 16: The method of any of aspects 6 through 15, wherein receiving the RAR comprises: receiving the indication of the timing advance group in one or more reserved bits in a PDCCH scrambled by a random access temporary identifier, wherein the RAR comprises the PDCCH.

Aspect 17: The method of any of aspects 6 through 16, wherein receiving the RAR comprises: receiving an indication of a CORESET pool index in one or more reserved bits in a PDCCH scrambled by a random access temporary identifier, wherein the CORESET pool index is associated with the timing advance group and wherein the RAR comprises the PDCCH.

Aspect 18: A method for wireless communications at a UE, comprising: receiving a RRC message indicating that a component carrier is associated with both a first timing advance group and a second timing advance group; receiving, via a first PDCCH order, a first control message triggering a first random access procedure, wherein the first PDCCH order is associated with a first CORESET pool index; receiving, via a second PDCCH order and during the first random access procedure, a second control message triggering a second random access procedure, wherein the second PDCCH order is associated with a second CORESET pool index; transmitting a first random access preamble via a first random access occasion on the component carrier and a second random access preamble via a second random access occasion on the component carrier; and receiving a RAR that comprises an indication of a timing advance group, wherein the RAR is associated with the first random access procedure based at least in part on the timing advance group corresponding to the first CORESET pool index or the first random access occasion, or the RAR is associated with the second random access procedure based at least in part on the timing advance group corresponding to the second CORESET pool index or the second random access occasion.

Aspect 19: The method of aspect 18, further comprising: determining the first random access procedure is associated with the timing advance group based at least in part on the first PDCCH order being associated with the first CORESET pool index and the first CORESET pool index being associated with the timing advance group, or the first random access occasion being associated with the timing advance group; or determining, the second random access procedure is associated with the timing advance group based at least in part on the second PDCCH order being associated with the second CORESET pool index and the second CORESET pool index being associated with the timing advance group, or the second random access occasion being associated with the timing advance group.

Aspect 20: The method of any of aspects 18 through 19, further comprising: monitoring for the RAR associated with the first random access procedure; and monitoring for the RAR associated with the second random access procedure.

Aspect 21: A method for wireless communications at a network entity, comprising: receiving a first control message indicating a first random access procedure for a UE; receiving a second control message indicating a second random access procedure during the first random access procedure, the second random access procedure for the UE; and transmitting, to the UE, a RAR associated with one of the first random access procedure or the second random access procedure, the RAR comprising an indication of one of the first random access procedure or the second random access procedure.

Aspect 22: The method of aspect 21, wherein transmitting the RAR comprises: transmitting a preamble identifier associated with the first random access procedure or the second random access procedure, wherein the indication included in the RAR is based at least in part on the preamble identifier.

Aspect 23: The method of any of aspects 21 through 22, wherein transmitting the RAR comprises: transmitting an indication of a timing advance group associated with the first random access procedure or the second random access procedure, wherein the indication included in the RAR is the indication of the timing advance group.

Aspect 24: The method of aspect 23, wherein transmitting the indication of the timing advance group comprises: transmitting a timing advance group identifier in a field of the RAR, wherein the indication of the timing advance group is based at least in part on the timing advance group identifier.

Aspect 25: The method of any of aspects 23 through 24, wherein transmitting the indication of the timing advance group comprises: transmitting the indication of the timing advance group in one or more fields of the RAR, wherein the one or more fields comprises a reserved field, a CSI request field, or both.

Aspect 26: The method of any of aspects 23 through 25, wherein transmitting the indication of the timing advance group comprises: transmitting a PDCCH scrambled by a random access temporary identifier, wherein the indication of the timing advance group is based at least in part on the random access temporary identifier and wherein the RAR comprises the PDCCH scrambled by the random access temporary identifier.

Aspect 27: The method of aspect 26, wherein transmitting the PDCCH scrambled by the random access temporary identifier comprises: transmitting an indication of a CORESET pool index in the PDCCH scrambled by the random access temporary identifier, wherein the CORESET pool index is based at least in part on the random access temporary identifier and is associated with the first random access procedure or the second random access procedure

Aspect 28: The method of any of aspects 26 through 27, wherein transmitting the PDCCH scrambled by the random access temporary identifier comprises: transmitting an indication of a timing advance group identifier in the PDCCH scrambled by the random access temporary identifier, wherein the timing advance group identifier is based at least in part on the random access temporary identifier and is associated with the first random access procedure or the second random access procedure.

Aspect 29: The method of any of aspects 23 through 28, wherein transmitting the indication of the timing advance group comprises: transmitting the indication of the timing advance group in one or more reserved bits in a PDCCH scrambled by a random access temporary identifier, wherein the RAR comprises the PDCCH.

Aspect 30: The method of any of aspects 21 through 29, wherein transmitting the RAR comprises: transmitting an indication of a CORESET pool index in one or more bits in a PDCCH scrambled by a random access temporary identifier, wherein the RAR comprises the PDCCH.

Aspect 31: An apparatus for wireless communications at a UE, comprising a processor; memory coupled with the processor; and instructions stored in the memory and executable by the processor to cause the apparatus to perform a method of any of aspects 1 through 5.

Aspect 32: An apparatus for wireless communications at a UE, comprising at least one means for performing a method of any of aspects 1 through 5.

Aspect 33: A non-transitory computer-readable medium storing code for wireless communications at a UE, the code comprising instructions executable by a processor to perform a method of any of aspects 1 through 5.

Aspect 34: An apparatus for wireless communications at a UE, comprising a processor; memory coupled with the processor; and instructions stored in the memory and executable by the processor to cause the apparatus to perform a method of any of aspects 6 through 17.

Aspect 35: An apparatus for wireless communications at a UE, comprising at least one means for performing a method of any of aspects 6 through 17.

Aspect 36: A non-transitory computer-readable medium storing code for wireless communications at a UE, the code comprising instructions executable by a processor to perform a method of any of aspects 6 through 17.

Aspect 37: An apparatus for wireless communications at a UE, comprising a processor; memory coupled with the processor; and instructions stored in the memory and executable by the processor to cause the apparatus to perform a method of any of aspects 18 through 20.

Aspect 38: An apparatus for wireless communications at a UE, comprising at least one means for performing a method of any of aspects 18 through 20.

Aspect 39: A non-transitory computer-readable medium storing code for wireless communications at a UE, the code comprising instructions executable by a processor to perform a method of any of aspects 18 through 20.

Aspect 40: An apparatus for wireless communications at a network entity, comprising a processor; memory coupled with the processor; and instructions stored in the memory and executable by the processor to cause the apparatus to perform a method of any of aspects 21 through 30.

Aspect 41: An apparatus for wireless communications at a network entity, comprising at least one means for performing a method of any of aspects 21 through 30.

Aspect 42: A non-transitory computer-readable medium storing code for wireless communications at a network entity, the code comprising instructions executable by a processor to perform a method of any of aspects 21 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a first control message in a first physical downlink control channel order triggering a first random access procedure, the first control message indicating a first preamble identifier associated with the first random access procedure;
receiving a second control message in a second physical downlink control channel order triggering a second random access procedure during the first random access procedure, the second control message indicating a second preamble identifier associated with the second random access procedure, wherein the first preamble identifier is different than the second preamble identifier;
transmitting a first random access preamble corresponding to the first preamble identifier and a second random access preamble corresponding to the second preamble identifier; and
receiving a random access response associated with one of the first random access procedure or the second random access procedure based at least in part on a preamble identifier indication included in the random access response.

2. The method of claim 1, further comprising:
monitoring for the random access response associated the first random access procedure; and
monitoring for the random access response associated with the second random access procedure.

3. The method of claim 1, wherein receiving the random access response comprises:
receiving the random access response associated with the first random access procedure based at least in part on the preamble identifier indication corresponding to the first preamble identifier; or
receiving the random access response associated with the second random access procedure based at least in part on the preamble identifier indication corresponding to the second preamble identifier.

4. The method of claim 1, further comprising:
receiving a physical downlink shared channel associated with the first random access procedure or the second random access procedure based at least in part on the preamble identifier indication included in the random access response, wherein the random access response comprises the physical downlink shared channel.

5. The method of claim 1, wherein receiving the first control message and the second control message comprises:
receiving the first physical downlink control channel order from a first network entity; and
receiving the second physical downlink control channel order from a second network entity different from the first network entity.

6. A method for wireless communications at a user equipment (UE), comprising:
transmitting a first random access preamble corresponding to a first preamble identifier as part of a first random access procedure;
transmitting, during the first random access procedure, a second random access preamble corresponding to a second preamble identifier, the second random access preamble associated with a second random access procedure; and
receiving a random access response associated with one of the first random access procedure or the second random access procedure based at least in part on an indication of a timing advance group in the random access response.

7. The method of claim 6, further comprising:
monitoring for the random access response associated with the first random access procedure; and
monitoring for the random access response associated with the second random access procedure.

8. The method of claim 6, further comprising:
receiving a first control message in a first physical downlink control channel order associated with the first random access procedure, the first control message indicating the first preamble identifier; and
receiving a second control message in a second physical downlink control channel order associated with the second random access procedure, the second control message indicating the second preamble identifier.

9. The method of claim 8, wherein receiving the first control message and the second control message comprises:
receiving the first control message in the first physical downlink control channel order from a first network entity; and
receiving the second control message in the second physical downlink control channel order from a second network entity different from the first network entity.

10. The method of claim 6, further comprising:
receiving a physical downlink shared channel associated with the first random access procedure or the second random access procedure based at least in part on the indication of the timing advance group included in the random access response, wherein the random access response comprises the physical downlink shared channel.

11. The method of claim 6, wherein receiving the random access response comprises:
receiving a timing advance group identifier in a field of the random access response, wherein the indication of the timing advance group is based at least in part on the timing advance group identifier.

12. The method of claim 6, wherein receiving the random access response comprises:
receiving the indication of the timing advance group in one or more fields of the random access response, wherein the one or more fields comprises a reserved field and a channel state information request field.

13. The method of claim 6, wherein receiving the random access response comprises:
receiving a physical downlink control channel scrambled by a random access temporary identifier, wherein the indication of the timing advance group is based at least in part on the random access temporary identifier and wherein the random access response comprises the physical downlink control channel scrambled by the random access temporary identifier.

14. The method of claim 13, wherein receiving the physical downlink control channel scrambled by the random access temporary identifier comprises:
receiving an indication of a control resource set pool index in the physical downlink control channel scrambled by the random access temporary identifier, wherein the control resource set pool index is based at least in part on the random access temporary identifier and is associated with the first random access procedure or the second random access procedure.

15. The method of claim 13, wherein receiving the physical downlink control channel scrambled by the random access temporary identifier comprises:
receiving an indication of a timing advance group identifier in the physical downlink control channel scrambled by the random access temporary identifier, wherein the timing advance group identifier is based at least in part on the random access temporary identifier and is associated with the first random access procedure or the second random access procedure.

16. The method of claim 6, wherein receiving the random access response comprises:
receiving the indication of the timing advance group in one or more reserved bits in a physical downlink control channel scrambled by a random access temporary identifier, wherein the random access response comprises the physical downlink control channel.

17. The method of claim 6, wherein receiving the random access response comprises:
receiving an indication of a control resource set pool index in one or more reserved bits in a physical downlink control channel scrambled by a random access temporary identifier, wherein the control resource set pool index is associated with the timing advance group and wherein the random access response comprises the physical downlink control channel.

18. A method for wireless communications at a user equipment (UE), comprising:
receiving a radio resource control message indicating that a component carrier is associated with both a first timing advance group and a second timing advance group;
receiving, via a first physical downlink control channel order, a first control message triggering a first random access procedure, wherein the first physical downlink control channel order is associated with a first control resource set pool index;
receiving, via a second physical downlink control channel order and during the first random access procedure, a second control message triggering a second random access procedure, wherein the second physical downlink control channel order is associated with a second control resource set pool index;
transmitting a first random access preamble via a first random access occasion on the component carrier and a second random access preamble via a second random access occasion on the component carrier; and
receiving a random access response that comprises an indication of a timing advance group, wherein the random access response is associated with the first random access procedure based at least in part on the timing advance group corresponding to the first control resource set pool index or the first random access occasion, or the random access response is associated with the second random access procedure based at least in part on the timing advance group corresponding to the second control resource set pool index or the second random access occasion.

19. The method of claim 18, further comprising:
determining the first random access procedure is associated with the timing advance group based at least in part on the first physical downlink control channel order being associated with the first control resource set pool index and the first control resource set pool index being associated with the timing advance group, or the first random access occasion being associated with the timing advance group; or
determining the second random access procedure is associated with the timing advance group based at least in part on the second physical downlink control channel order being associated with the second control resource set pool index and the second control resource set pool index being associated with the timing advance group, or the second random access occasion being associated with the timing advance group.

20. The method of claim 18, further comprising:
monitoring for the random access response associated with the first random access procedure; and
monitoring for the random access response associated with the second random access procedure.

21. A method for wireless communications at a network entity, comprising:
receiving a first control message indicating a first random access procedure for a user equipment (UE);
receiving a second control message indicating a second random access procedure during the first random access procedure, the second random access procedure for the UE; and
transmitting, to the UE, a random access response associated with one of the first random access procedure or the second random access procedure, the random access response comprising an indication of one of the first random access procedure or the second random access procedure.

22. The method of claim 21, wherein transmitting the random access response comprises:
transmitting a preamble identifier associated with the first random access procedure or the second random access procedure, wherein the indication included in the random access response is based at least in part on the preamble identifier.

23. The method of claim 21, wherein transmitting the random access response comprises:
transmitting an indication of a timing advance group associated with the first random access procedure or the second random access procedure, wherein the indication included in the random access response is the indication of the timing advance group.

24. The method of claim 23, wherein transmitting the indication of the timing advance group comprises:
transmitting a timing advance group identifier in a field of the random access response, wherein the indication of the timing advance group is based at least in part on the timing advance group identifier.

25. The method of claim 23, wherein transmitting the indication of the timing advance group comprises:
transmitting the indication of the timing advance group in one or more fields of the random access response, wherein the one or more fields comprises a reserved field, a channel state information request field, or both.

26. The method of claim 23, wherein transmitting the indication of the timing advance group comprises:
transmitting a physical downlink control channel scrambled by a random access temporary identifier, wherein the indication of the timing advance group is based at least in part on the random access temporary identifier and wherein the random access response comprises the physical downlink control channel scrambled by the random access temporary identifier.

27. The method of claim 26, wherein transmitting the physical downlink control channel scrambled by the random access temporary identifier comprises:
transmitting an indication of a control resource set pool index in the physical downlink control channel scrambled by the random access temporary identifier, wherein the control resource set pool index is based at least in part on the random access temporary identifier and is associated with the first random access procedure or the second random access procedure.

28. The method of claim 26, wherein transmitting the physical downlink control channel scrambled by the random access temporary identifier comprises:
transmitting an indication of a timing advance group identifier in the physical downlink control channel scrambled by the random access temporary identifier, wherein the timing advance group identifier is based at least in part on the random access temporary identifier and is associated with the first random access procedure or the second random access procedure.

29. The method of claim 23, wherein transmitting the indication of the timing advance group comprises:
transmitting the indication of the timing advance group in one or more reserved bits in a physical downlink control channel scrambled by a random access temporary identifier, wherein the random access response comprises the physical downlink control channel.

30. The method of claim 21, wherein transmitting the random access response comprises:
transmitting an indication of a control resource set pool index in one or more bits in a physical downlink control channel scrambled by a random access temporary identifier, wherein the random access response comprises the physical downlink control channel.
